(19) United States
(12) Patent Application Publication
(10) Pub. No.: US 2023/0055369 A1
(43) Pub. Date: Feb. 23, 2023

(54) PLANT SOURCED PROTEIN-POLYPHENOL COMPLEXES

(71) Applicant: CRUSH DYNAMICS INC., SUMMERLAND (CA)

(72) Inventors: William Leslie Broddy, Summerland (CA); Gary Edward Strachan, Summerland (CA)

(21) Appl. No.: 17/789,767

(22) PCT Filed: May 25, 2021
(86) PCT No.: PCT/IB2021/059695

§ 371 Date: Jun. 28, 2022

Related U.S. Application Data
(60) Provisional application No. 63/094,050, filed on Oct. 20, 2020.

(51) Int. Cl. A23J 3/14; A23J 3/22; A23J 3/26

(52) U.S. Cl. CPC A23J 3/14; A23J 3/227; A23J 3/26

(57) ABSTRACT

Compositions and methods are provided, wherein one or more plant protein(s) are combined with one or more fruit, vegetable, nut or grain sources of phenolics to generate protein-phenol complexes within the mixture. The source of phenolics primarily derive from plant waste, residuals, by-products or side streams, such as, for example, the solids which remain after the extraction of juice from fruit or oil pressed from olives, nuts or grains (e.g., pomace), or fruit and vegetables, etc., which could not be sold for some reason or another. In one embodiment, this mixture constitutes an Admixture that can be added to meat analogue formulations. In one embodiment, this mixture constitutes a Base Substance to generate a Meat Analogue and/or Final Product, which can provide a replacement for different types of meat including beef, buffalo, deer, chicken, turkey, pork, fish, shellfish, etc.

### CROSS-REFERENCE TO RELATED APPLICATIONS

This application claims the benefit of U.S. Provisional application No. 63/094,050, filed Oct. 20, 2020, entitled, “PLANT SOURCED PROTEIN-POLYPHENOL COMPLEXES,” the disclosure of which is being incorporated by reference in its entirety.

### FIELD OF THE INVENTION

The present invention relates to compositions useful as a precursor to meat substitute, specifically compositions made from pomace and one or more plant derived proteins, and to methods for making and methods for using such compositions.

### SUMMARY OF THE INVENTION

The composition and process described and claimed herein have many attributes and embodiments including, but not limited to, those set forth or described or referenced in this Summary of the Invention. It is not intended to be all-inclusive and the invention described and claimed herein is not limited to or by the features or embodiments identified in this Summary of the Invention, which is included for purposes of illustration only and not restriction.

A composition and method are provided, wherein one or more plant protein(s) are combined with one or more fruit, vegetable, nut or grain sources of phenolics to generate protein-phenol complexes within the mixture. The source of phenolics primarily derive from plant waste, residuals, by-products or side streams, such as, for example, the solids which remain after the extraction of juice from fruit or oil pressed from olives, nuts or grains (e.g., pomace), or fruit and vegetables, etc., which could not be sold for some reason or another. In one embodiment, the one or more sources of phenolics comprise, consist essentially of, or consist of pomace, wine derivatives (pomace, with or without lees). In one embodiment, this mixture constitutes an Admixture that can be added to meat analogue formulations to provide a Base Substance or a Meat Analogue and/or Final Product. In one embodiment, this mixture provides a Base Substance, which is then modified in one or more steps in order to create a Meat Analogue and/or a Final Product. The Meat Analogue and/or Final Product can provide a replacement for different types of meat including beef, buffalo, deer, chicken, turkey, pork, fish, shellfish, etc.

The present invention provides a composition comprising FVNG-pomace and one or more plant proteins. Optionally, the FVNG-pomace is a fermented PVNG-pomace that has been fermented prior to combining with one or more plant proteins.

In one embodiment, the ratio of FVNG-pomace to the one or more plant proteins consists of about 5% to 200% (dry w/w). In one embodiment, the ratio of FVNG-pomace to the one or more plant proteins consists of about 5% to 50% (dry w/w). In one embodiment, the ratio of FVNG-pomace to the one or more plant proteins consists of about 50% to 100% (dry w/w). In one embodiment, the ratio of FVNG-pomace to the one or more plant proteins consists of about 100% to 150% (dry w/w). In one embodiment, the ratio of FVNG-pomace to the one or more plant proteins consists of about 150% to 200% (dry w/w). Furthermore, in one embodiment, the composition, which can be an Admixture and/or a Base Substance, additionally comprises one or more of exogenous: starches; fats or oils; carbohydrate; gums; hydrocolloids; acidulants; stabilizers; emulsifiers; flavor precursors; protein-fiber binding agents; lactones; colorings; plant-based fibers; fungal mycelium; antioxidants; and phenolics, which may be formulated into a Meat Analogue.

In one embodiment, the composition comprises a complex of one or more plant proteins and FVNG-pomace phenolics, wherein the percentage of plant proteins that are complexed with phenolics is about 5% to 100%. In one embodiment, the percentage of plant proteins that are complexed with phenolics is about 5% to 20%. In one embodiment, the percentage of plant proteins that are complexed with phenolics is about 20% to 40%. In one embodiment, the percentage of plant proteins that are complexed with phenolics is about 40% to 60%. In one embodiment, the percentage of plant proteins that are complexed with phenolics is about 60% to 80%. In one embodiment, the percentage of plant proteins that are complexed with phenolics is about 80% to 100%. Furthermore, in one embodiment, the composition, which can be an Admixture and/or a Base Substance, additionally comprises one or more of exogenous: starches; fats or oils; carbohydrate; gums; hydrocolloids; acidulants; stabilizers; emulsifiers; flavor precursors; protein-fiber binding agents; lactones; colorings; plant-based fibers; fungal mycelium; antioxidants; and phenolics, which may be formulated into a Meat Analogue.

The present invention further provides a meat analogue comprising FVNG-pomace and one or more plant proteins, wherein the ratio of FVNG-pomace to the one or more plant proteins consists of about 5% to 200% (dry w/w). In one embodiment, the ratio of FVNG-pomace to the one or more plant proteins in the Meat Analogue consists of about 5% to 50% (dry w/w). In one embodiment, the ratio of FVNG-pomace to the one or more plant proteins in the Meat Analogue consists of about 50% to 100% (dry w/w). In one embodiment, the ratio of FVNG-pomace to the one or more plant proteins in the Meat Analogue consists of about 100% to 150% (dry w/w). In one embodiment, the ratio of FVNG-pomace to the one or more plant proteins in the Meat Analogue consists of about 150% to 200% (dry w/w). In one option, the Meat Analogue may be processed by a texturizing means, including but not limited to: extrusion; laminating; 3D food printing.

The present invention further provides a Meat Analogue comprising a complex of one or more plant proteins and FVNG-pomace phenolics, wherein the percentage of plant proteins that are complexed with phenolics is about 5% to 100%. In one embodiment, the percentage of plant proteins in the Meat Analogue that are complexed with phenolics is about 5% to 20%. In one embodiment, the percentage of plant proteins in the Meat Analogue that are complexed with phenolics is about 20% to 40%. In one embodiment, the percentage of plant proteins in the Meat Analogue that are complexed with phenolics is about 40% to 60%. In one embodiment, the percentage of plant proteins in the Meat Analogue that are complexed with phenolics is about 60% to 80%. In one embodiment, the percentage of plant proteins in the Meat Analogue that are complexed with phenolics is about 80% to 100%. In one option, the Meat Analogue may be processed by a texturizing means, including but not limited to: extrusion; laminating; 3D food printing.

The invention further provides a method of making a composition comprising FVNG-pomace and one or more plant proteins, wherein the ratio of FVNG-pomace to the one or more plant proteins consists of about 5% to 200% (dry w/w), comprising the steps of: optionally preparing one or more sources of plant protein; preparing FVNG-pomace; optionally fermenting the FVNG-pomace; combining one or more sources of protein with FVNG-pomace and/or fermented FVNG-pomace to generate protein-polyphenol complexes in either an Admixture or a Base Substance; optionally, conducting one or more Modification Steps to the Admixture or Base Substance; and optionally, formulating into a Meat Analogue.

The invention further provides a method of making a composition comprising a complex of one or more plant proteins and FVNG-pomace phenolics, wherein the percentage of plant proteins that are complexed with phenolics is about 5% to 100% comprising the steps of: optionally preparing one or more sources of plant protein; preparing FVNG-pomace; optionally fermenting the FVNG-pomace; combining one or more sources of protein with FVNG-pomace and/or fermented FVNG-pomace to generate protein-polyphenol complexes in either an Admixture or a Base Substance; optionally, conducting one or more Modification Steps to the Admixture or Base Substance; and optionally, formulating into a Meat Analogue.

The invention further provides a method of using a composition comprising FVNG-pomace and one or more plant proteins, to modify the sensory qualities of a meat analogue, wherein the ratio of FVNG-pomace to the one or more plant proteins consists of about 5% to 200% (dry w/w) to add to a Meat Analogue formulation to modify the sensory qualities thereof.

The invention further provides a method of using a composition comprising a complex of one or more plant proteins and FVNG-pomace phenolics to modify the sensory qualities of a meat analogue, wherein the percentage of plant proteins that are complexed with phenolics is about 5% to 100%.

### BACKGROUND OF THE INVENTION

All publications mentioned throughout this application are fully incorporated herein by reference, including all references cited therein.

Consumer demand for non-meat based food products having higher nutrition and more natural ingredients is increasing. The current state of the art for meat substitute compositions largely involves the extrusion of soy/grain mixture, resulting in products which fail to replicate the experience of cooking and eating meat. Common limitations of these products are a texture and mouthfeel that are more homogenous than that of equivalent meat products.

One of the critical aspects of a meat substitute (meat analogue) is to replicate the mouthfeel of a cooked meat. One explanation for the transition between raw meat to appropriately cooked meat to over-cooked meat relates to the degree of denaturation of the primary proteins within muscle. The general muscle structure found in meat such as beef, pork, lamb, and poultry is made up of many bundles of protein fibers, which are made of two proteins called actin and myosin. When proteins are in their native state, the long chain of amino acids that make up a protein cause it to fold up into a characteristic conformation.

Generally, hydrophobic (water-hating) residues are folded into the inside of the protein, where they can interact with each other, while hydrophilic (water-loving) residues are on the outside of the protein, where they can interact with the surrounding liquid. When a protein denatures, this chain unfolds, exposing many hydrophobic residues. If there are other unfolded proteins present, the denatured proteins tend to stick together because their exposed hydrophobic residues interact with those on a neighboring protein.

Cooking a steak to its ideal qualities involves partial denaturation of the proteins. When a steak is cooked at medium temperature (130-155° F.), the myosin has reached the temperature at which it denatures/unfolds, yet the actin, which is more thermostable retains its structure. The steak becomes much less “chewy,” partially because cells break down and the myosin proteins are denatured, allowing the muscle fibers to be more easily broken apart. If the steak continues to cook until it is well done it can become tough and dry, likely because all of the protein has been denatured, releasing the water (moisture) within the muscle.

There are meat substitutes (meat analogues) available that use plant proteins to form substances having a meat-like texture, typically mimicking or attempting to mimic the fibrous qualities found in animal protein, particularly muscle fibers. The majority of such products are formed using soy protein, together with a number of other additives to enhance flavor and texture, such as gluten and/or wheat-based products.

Pea Protein as an Example of Plant Protein Alternatives

There are a number of plant proteins, which have been used in many consumer products as protein alternatives for gluten, animal, milk, and soybean-based proteins. One common example is pea protein, which is used herein to demonstrate the principles of the process and compositions, but the process and compositions can comprise any suitable plant source, including marine sources. One skilled in the art would know which protein sources to incorporate based on the characteristics of the source material and the desired outcome for a specific meat substitute.

Pea protein is used as a low-cost functional ingredient in food manufacturing to improve the nutritional value and texture of food products, by optimizing the viscosity, emulsification, gelation, stability, or fat-binding properties of food and have the ability to form stable foams. There have been attempts to introduce pea protein as a texturizing source for meat substitutes. Pea, however, has very short fibers and is not as sticky as is soy, which tends to give the meat substitute a soft mushy mouthfeel.

Peas as traditionally harvested and dried, have a hull portion (about 6-10% dry weight of whole pea) and a seed portion (about 90-94% dry weight of whole pea). When the hull is removed, the seed portion has a content of up to about 12-15% total weight moisture, about 50-65% carbohydrates, the predominant being starch and also including monosaccharides and disaccharides, about 2-4% total weight fat, about 10-30% total weight protein.

There are several classes of protein in the pea seed, comprising globulins, albumins, prolamin, and glutelin. The globulins account for 70-80% of the protein, are salt soluble and act as the storage proteins for the seed. Globulins can be further classified into legumin and vicilin, which belong to the 11S and 7S seed storage protein classes, respectively. Legumin is a hexameric protein, and vicilin proteins are trimers. The albumins constitute 10-20% of the protein, are water soluble and considered the metabolic and enzymatic proteins.

Plant-Based Residue Biomass

Plant-based residue biomass constitutes leftover by-products of the agri-food industry. Food waste (residue, side-streams, etc.) is produced in all the phases of food life cycle, i.e. during agricultural production, industrial manufacturing, processing and distribution. Significant losses and waste are becoming a serious nutritional, economical, and environmental problem. The FAO has estimated that losses and waste in fruits and vegetables are the highest among all types of foods, and may reach up to 60%. Fruit and vegetable losses and waste also indirectly include wasting of critical resources such as land, water, fertilizers, chemicals, energy, and labor. These immense quantities of lost and wasted food commodities also contribute to vast environmental problems as they decompose in landfills and emit harmful greenhouse gases. These wastes are prone to microbial spoilage causing objectionable odors and environmental problems.

When fruits and vegetables are pressed or processed for juice, oil, wine, or other products, the organic process waste generated is known as pomace (or marc). Pomace typically represents approximately 20% to 35% of the original fruit or vegetable matter and is generally composed of carbohydrates, dietary fibers and small amounts of protein. Pomace also contains the majority of the polyphenolic compounds present in fresh, unprocessed fruit and vegetables. For example, after conventional apple juice production, the amount of polyphenolic compounds in the processed apple juice is reduced by at least 58% to 95% compared to the amount of polyphenolic compounds in whole unprocessed apples. Pomace is therefore a rich source of polyphenolic compounds.

One example of an industry that produced significant amounts of food waste is the winemaking industry. Winemaking produces millions of tons of leftovers and residues, constituting an ecological and economical waste management issue for the wineries, which send most of it to the landfill, costing the winery fees for bin drop-off, removal, haulage and tipping fees in addition to winery management costs. Addressing these issues in an appropriate manner places a financial burden on most of the wineries, especially the smaller ones

The winemaking process generates two major residues, which can be harvested. The major residues from the winemaking process after the de-stemming and crush steps are known as derivatives. Winery derivatives comprise:
a) pomace (marc) consisting of grape skin, grape pulp and grape seed derived from varietal grapes, which have been crushed and pressed as part of the winemaking process; and
b) lees consisting of spent wine yeast, tartaric acid, grape skin pigment and grape pulp sediment, which have been-expressed from the wine after fermentation and again after aging.

Grape pomace provides substantial nutritional potential as supplements and to fortify food. For example, 15 grams (˜1 tbsp.) of powdered derivative may contain up to 900 mg of phenols, 150 mg of tannins (catechin), 2000 mg of protein, 180 mg of potassium, 120 mg of magnesium, 4 mg of iron, 4% DV of riboflavin, 125% DV of vitamin E and 3% DV of vitamin K).

In general, wine lees is residue that forms at the bottom of wine containers consisting of: 1) first and second-fermentation lees, which are formed during the alcoholic and malolactic fermentations, respectively (herein, lees); 2) during storage or after treatments (herein, first-rack lees); and 3) aging wine lees formed during wine aging in wood barrels collected after the filtration or centrifugation of the wine (herein, second-rack lees), The main characteristics of wine lees are acidic pH (between 3 and 5), a chemical oxygen demand above 30,000 mg/L, potassium levels around 2500 mg/L, and phenolic compounds in amounts up to 1000 mg/L Approximately 30% of red wine lees are protein that is produced from yeast cell wall material, which contains 30-60% 3-b-D-glucan in dry weight.

More than 70% of total phenolics are not extracted during the wine-making process because 60%— 70% reside in grape seeds, so remain in the pomace (marc).

The phenolic compounds from red grapes are significantly higher both in quantity and variety than in white ones (green grapes). The most abundant group of phenolics are flavonoids (C₆-C₃-C₆ backbone) and include: anthocyanins, flavanols (catechins), proanthocyanidins (tannins) and flavonols. Non-flavonoid phenolics include hydroxycinnamic acids (C₆-C₃ backbone), stilbenes (C₆-C₂-C₆ backbone—e.g., resveratrol) and hydroxybenzoates (C₆-C₁ backbone—e.g., salicylic acid).

### BRIEF DESCRIPTION OF FIGURES

The drawings are not necessarily to scale, emphasis instead generally being placed upon illustrating the principles described herein. In the drawings, like numerals are used to indicate like parts throughout the various views. The foregoing and other features and advantages of the subject matter disclosed herein will be made apparent from the following detailed description taken in conjunction with the accompanying drawings, in which:

The foregoing and other features and advantages of the subject matter disclosed herein will be made apparent from the following detailed description taken in conjunction with the accompanying drawings, in which:

FIG. 1A provides a high-level overview of the process in accordance with an embodiment of the invention.

FIG. 1B provides a high-level overview of the process in accordance with an embodiment of the invention.

FIG. 2 illustrates the process, wherein one of the Modification Steps is a fermentation step, in accordance with an embodiment of the invention.

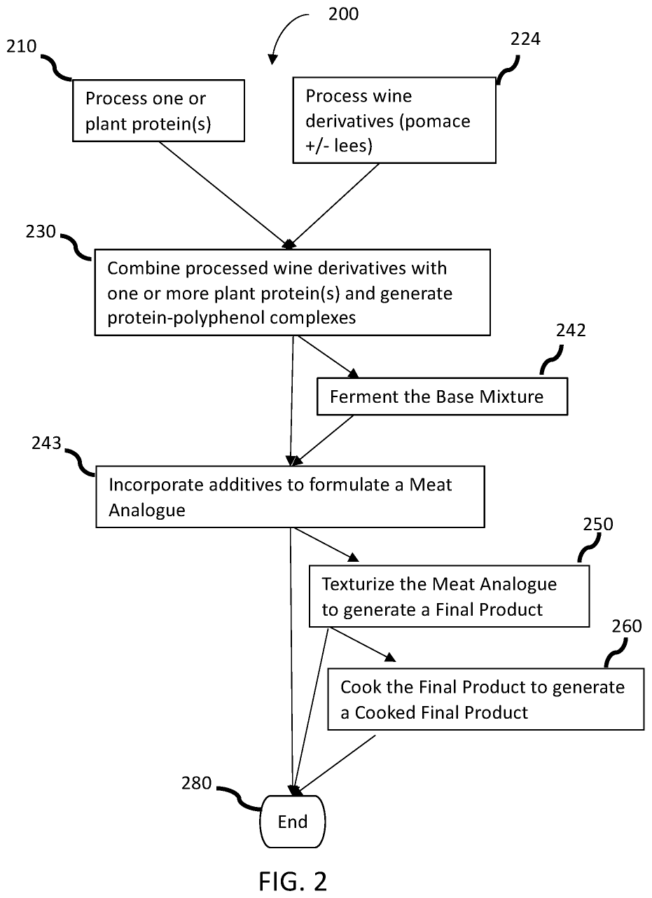

FIG. 3 teaches the process, wherein one of the Modification Steps is the incorporation of one or more additives un accordance with an embodiment of the invention.

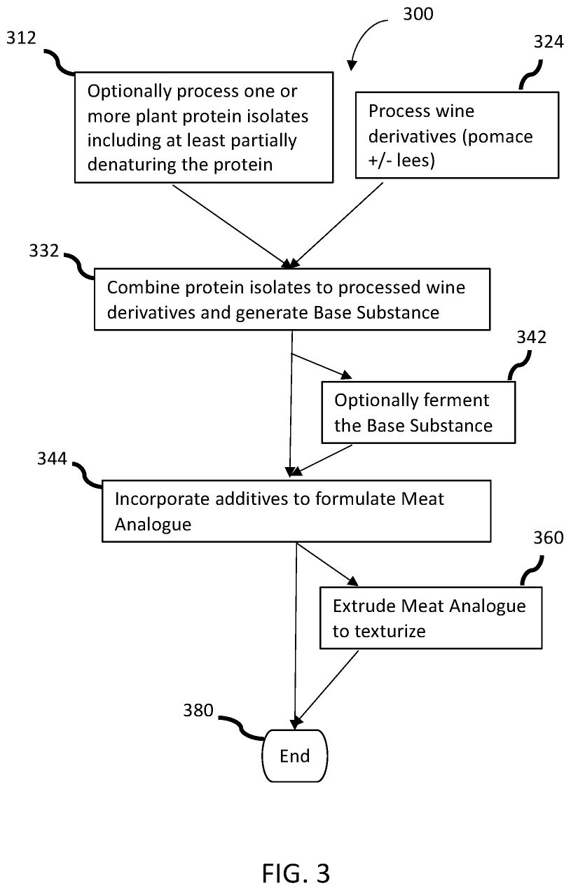

FIG. 4 shows the process, in accordance with an embodiment of the invention, wherein the process of generating protein-polyphenol complexes includes partially denature protein isolates in presence of wine derivatives.

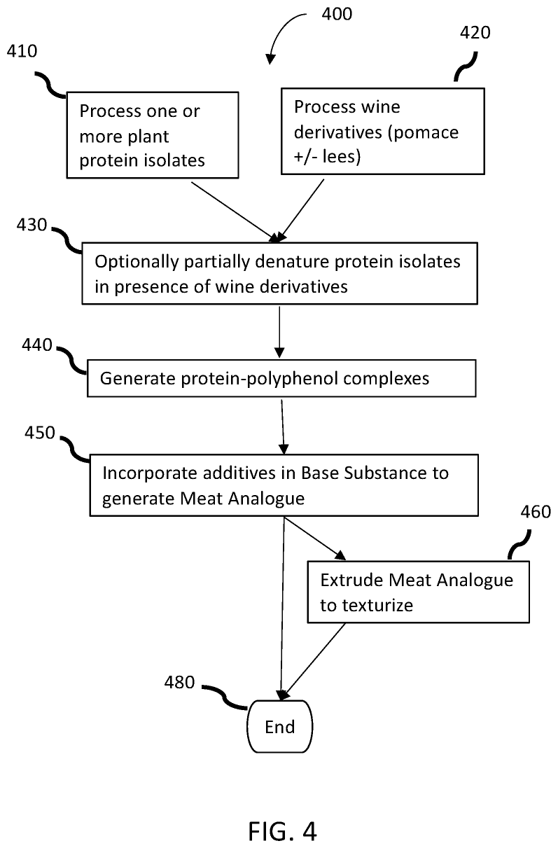

FIG. 5 provides the process wherein a fermentation step is included and the resulting ethanol is removed, in accordance with an embodiment of the invention.

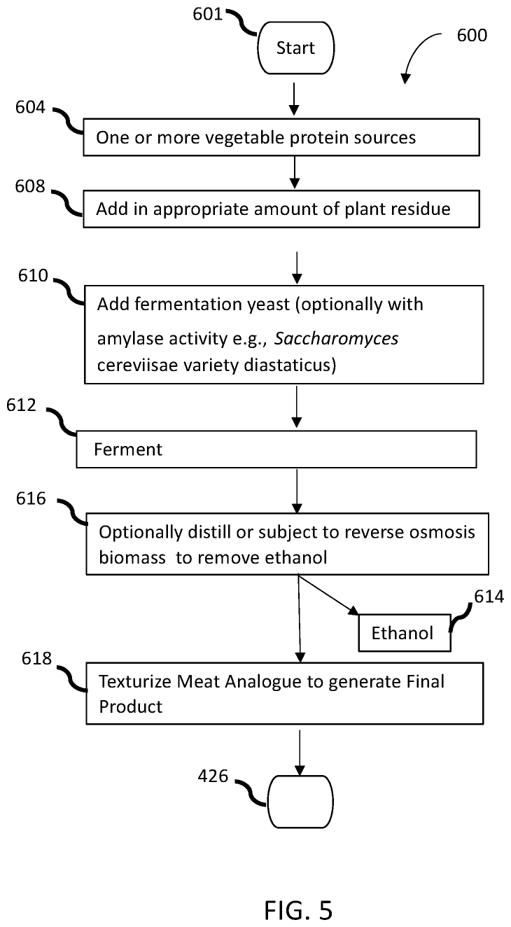

FIG. 6 illustrates one process for processing the one or more sources of plant protein in accordance with an embodiment of the invention. This process is continued in FIG. 7.

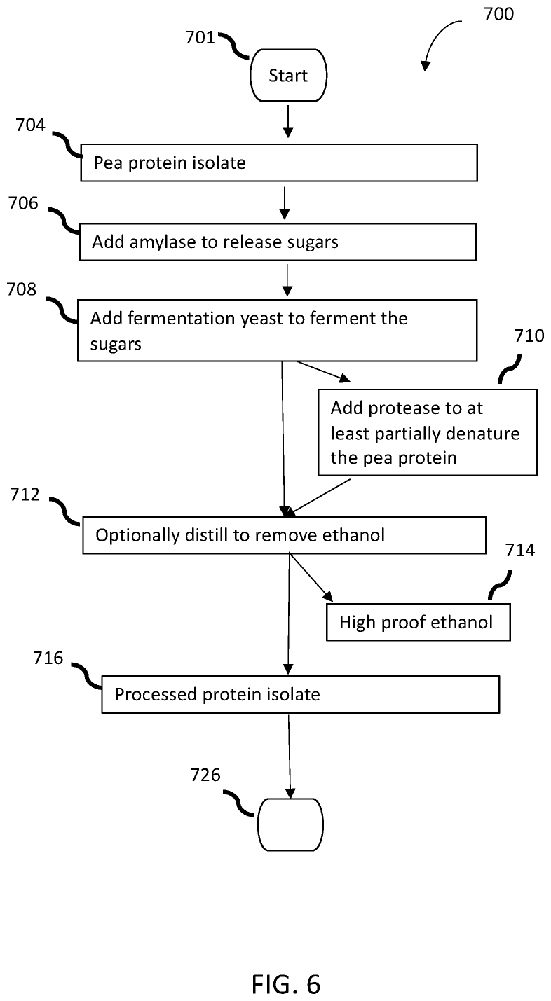

FIG. 7 teaches the continuation of the process of FIG. 6, in accordance with an embodiment of the invention.

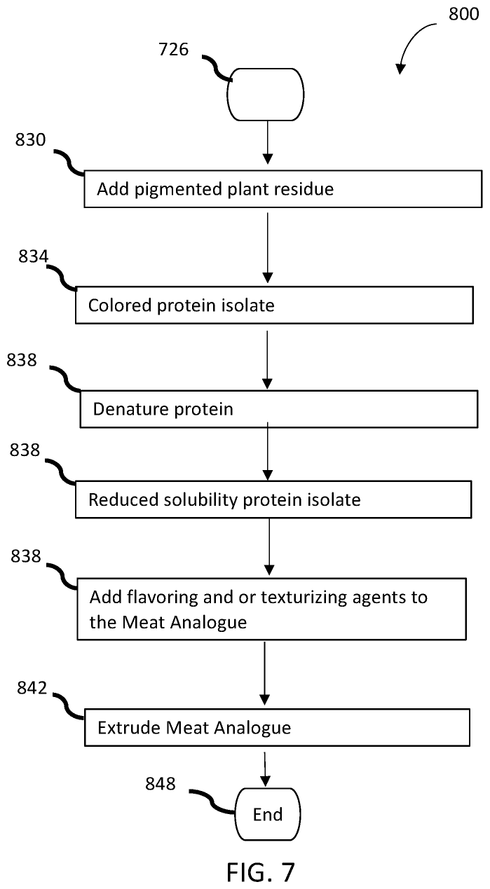

FIG. 8 presents the results obtained in Example 2, in accordance with an embodiment of the invention.

FIG. 9 presents the results obtained in Example 3, in accordance with an embodiment of the invention.

FIG. 10 presents the results obtained in Example 4, in accordance with an embodiment of the invention.

### DETAILED DESCRIPTION OF THE INVENTION

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, structures and components may be shown in block diagram form in order to avoid obscuring the concepts of the described subject matter. Wherever possible, the same reference numbers will be used throughout the drawings to refer to the same or the like parts.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase.

The term comprising means “including but not limited to,” unless expressly specified otherwise. When used in the appended claims, in original and amended form, the term “comprising” is intended to be inclusive or open-ended and does not exclude any additional, unrecited element, method, step or material. The term “consisting of” excludes any element, step or material other than those specified in the claim. As used herein, “up to” includes zero, meaning no amount is added in some embodiments.

The term “about” generally refers to a range of numerical values (e.g., +/−1-3% of the recited value) that one of ordinary skill in the art would consider equivalent to the recited value (e.g., having the same function or result). In some instances, the term “about” includes the values disclosed and may include numerical values that are rounded to the nearest significant figure. Moreover, all numerical ranges herein should be understood to include all integer, whole or fractions, within the range recited.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural referents unless the context clearly dictates otherwise. That is, unless clearly specified otherwise, as used herein the words “a” and “an” and the like carry the meaning of “one or more” or “at least one.” The phrases “at least one,” “one or more,” “or,” and “and/or” are open-ended expressions that can be both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” can mean A alone, B alone, C alone, A and B together, A and C together, B and C together, or A, B and C together. It is also to be noted that the terms “comprising,” “including,” and “having” can be used interchangeably.

As used herein, the term “phenolic” or “phenolics” refers to a group of related compounds that include, but are not limited to, phenolic acids and analogues (e.g., hydroxybenzoic acids (e.g., gallic acid, p-hydroxybenzoic acid, protocatechuic acid, vanillic acid, and syringic acid) and hydroxycinnamic acids (e.g., ferulic acid, caffeic acid, p-coumaric acid, chlorogenic acid, and sinapic acid), flavonoids (e.g. flavones, flavanols, flavanones, flavonols isoflavones, anthocyanins), tannins, stilbenes, curcuminoids, coumarins (e.g., hydroxylcoumarins, furocoumarins and isofurocoumarin, pyranocoumarins, bicoumarins, dihydro-isocoumarins), lignans, quinones (anthraquinones, phenanthraquinones, naphthoquinones, and benzoquinones). Phenolic compounds are generally understood to be bioactive having, for example, antioxidant, anticarcinogenic, antimutagenic and anti-inflammatory properties.

The present invention relates to compositions comprising fruit, vegetable, nut or grain (FVNG) waste (residues, by-products, side-streams), which will herein be referred to as FVNG-pomace. Pomace is generally known as the pulpy material remaining after the juice has been pressed from fruit or vegetables, and after the extraction of oil from nuts, seeds, or fish. As used herein, FVNG-pomace comprises not only the pulpy material that remains after removing the juice or oil, but other forms of FVNG waste, also referred to in the industry as residues or side-streams.

These side-streams are, for example, fruit, vegetables, nuts and grains, that were either not harvested and/or sold for some reason and would normally become part of the agricultural waste stream if not put to some other use. FVNG-pomace can derive from one or more sources, such that the term FVNG-pomace can be singular or plural with regards to the source input(s).

The process and methods described herein are used to modify the sensory qualities of meat analogues by forming protein-polyphenol complexes, wherein the FVNG-pomace comes from plant residue.

In one embodiment, the process and methods provide for making plant-based products that can mimic red meat, including the fibrousness, heterogeneity in texture, beefy or other meat flavor, and red-to-brown color transition during cooking of ground meat, without off flavors. In one embodiment, this system, methods and processes provide for making plant-based products that can mimic white meat, including the fibrousness, heterogeneity in texture, flavor, and color transition during cooking, without off flavors.

In one embodiment, the product of the process and methods is in the form similar to a ground meat. In one embodiment, the Final Product 155 is then cut into the required size as determined by the potential end use, for example cubes, slices, strips or chunks, packaged and stored under standard conditions.

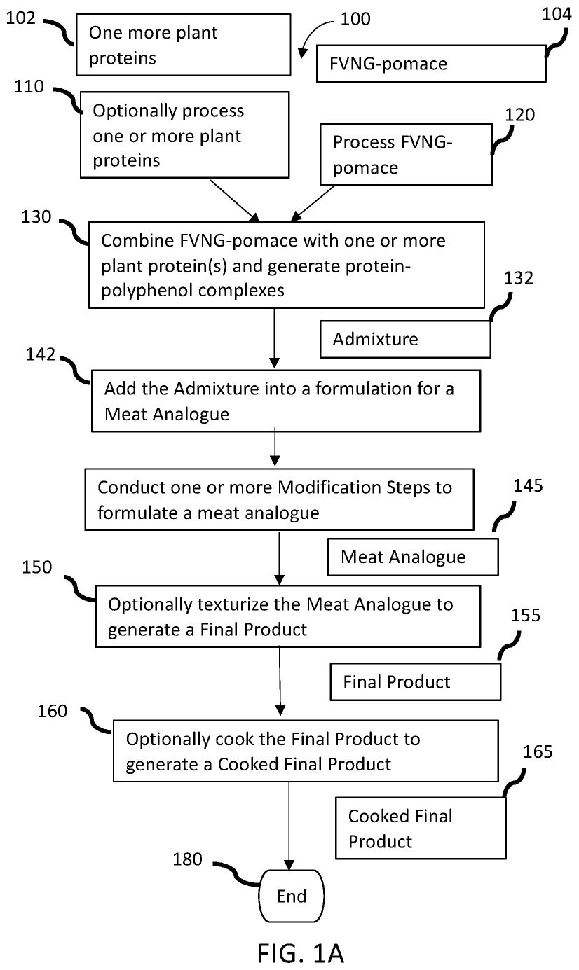

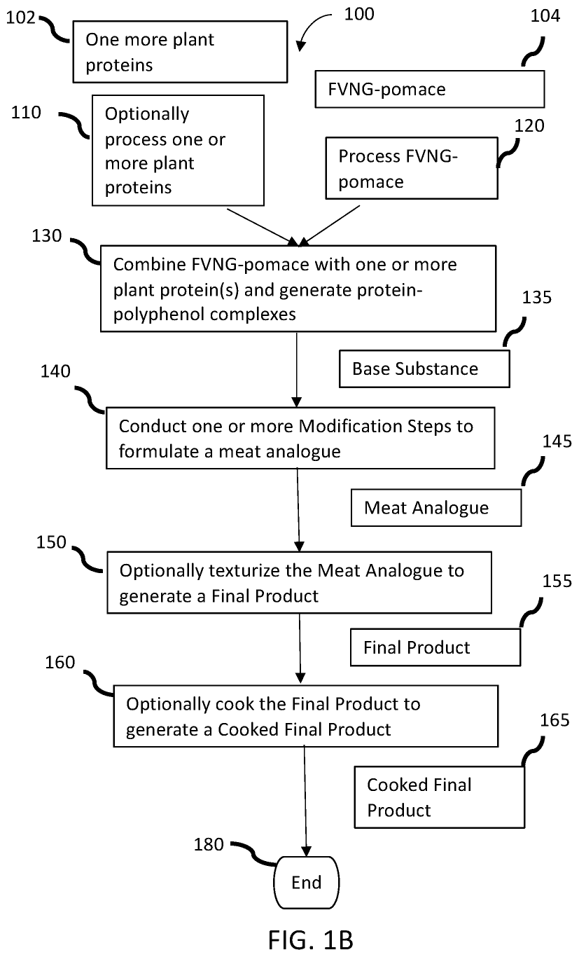

FIG. 1A and FIG. 1B provides an overview of the process 100, wherein one or more plant proteins 102 are combined with FVNG-pomace 104, to generate protein-polyphenol complexes within the mixture 130. FIG. 1A provides this process as a somewhat parallel process, whereas FIG. 1B illustrates this process as somewhat of a more linear or sequential process. In one embodiment, as illustrated in FIG. 1A, this composition is an admixture 132, which is designed to add to a formulation for a Meat Analogue 143, which is then modified in one or more steps 140 in order to create a Meat Analogue 145. In one embodiment, as illustrated in FIG. 1B, this mixture is a Base Substance 135, which is then modified in one or more steps 140 in order to create a Meat Analogue 145. The Meat Analogue 145 can provide a replacement for different types of meat including beef, buffalo, deer, chicken, turkey, pork, fish, shellfish, etc.

In one embodiment, processing the FVNG-pomace 120 includes adding lees to the FVNG-pomace prior to forming the protein-polyphenol complexes. In one embodiment, one of the modification steps 140 comprises adding lees to the Admixture 132 or the Base Substance 135 in order to modify its characteristics after forming the protein-polyphenol complexes 130. In one embodiment, the process 100 comprises using fermentation to enhance the characteristics of the Final Product 155 155 wherein fermentation can be conducted to either of the source materials (i.e., the one or more sources of plant protein 102 and/or the FVNG-pomace), and/or one of the modification steps used to convert the Base Substance 135 into a Meat Analogue 145.

In one embodiment, one of the modification steps 140 includes texturizing the Base Substance 135. In one embodiment, the Base Substance 135 is texturized via extrusion. In one embodiment, the Base Substance 135 is texturized by lamination. In one embodiment, the Base Substance 135 is texturized by a process similar to papermaking, wherein the fibers are promoted to align in the same direction with one another.

In one embodiment, one of the steps includes texturizing the Meat Analogue 145. In one embodiment, the Meat Analogue 145 is texturized via extrusion. In one embodiment, the is Meat Analogue 145 texturized by lamination. In one embodiment, the Meat Analogue 145 is texturized by a process similar to papermaking, wherein the fibers are promoted to align in the same direction with one another.

In one embodiment, the one or more sources of plant protein 102 may comprise, consist essentially of, or consist of vegetable, fruit, nut or cereal protein, or any combination of any two or more thereof. In one embodiment the one or more sources of plant protein 102 may comprise, consist essentially of, or consist of two or more, or three or more, or four or more separate sources of vegetable, fruit, nut or cereal protein, or any combination of any two or more thereof.

In one embodiment, the FVNG-pomace 104 comprise, consist essentially of, or consist of pomace, wine derivatives (pomace, with or without lees).

In one embodiment, a viable Meat Analogue 145 would comprise:
One or more plant protein(s), mixed with FVNG-pomace 104, wherein a portion of the proteins are complexed with phenolics;
Optional additives comprise one or more:
   plant sourced fibrous component;
   one or more flavoring agents;
   one or more plant sourced fat(s),
   one or more carbohydrate-based gel(s); and
   one or more binding agent(s).

According to one embodiment, the amount of one or more plant proteins 102 and the amount of FVNG-pomace 104 to be combined 130, is determined by the protein content of the plant source and the polyphenol content of the FVNG-pomace 104.

According to one embodiment, the carbohydrate, fat, starch, etc., content of each source material will impact the amount of one or more plant proteins 102 and the amount of FVNG-pomace 104 to be combined to generate the Admixture 132 or Base Substance 135.

In one embodiment, an Admixture 132 is provided comprising FVNG-pomace and one or more plant proteins, wherein the ratio of the FVNG-pomace to total plant protein consists of about 5% to 200% (dry w/w). In some embodiments, the Admixture 132 comprises, consists essentially of, or consists of about 5% to about 200%, about 5% to about 190%, about 5% to about 180%, about 5% to about 140%, about 5% to about 130%, 5% to about 120%, about 5% to about 110%, about 5% to about 100%, about 5% to about 90%, about 5% to about 80%, about 5% to about 70%, about 5% to about 60%, about 5% to about 50%, about 5% to about 90%, about 5% to about 80%, about 5% to about 70%, about 5% to about 60%, about 5% to about 50%, about 5% to about 40%, about 5% to about 35%, about 5% to about 30%, about 5% to about 25%, about 5% to about 20%, about 5% to about 15%, about 5% to about 10%, about 10% to about 70%, about 10% to about 60%, about 10% to about 50%, about 10% to about 40%, about 10% to about 35%, about 10% to about 30%, about 10% to about 25%, about 10% to about 20%, about 10% to about 15%, about 15% to about 70%, about 15% to about 60%, about 15% to about 50%, about 15% to about 40%, about 15% to about 35%, about 15% to about 30%, about 15% to about 25%, about 15% to about 20%, about 20% to about 70%, about 20% to about 60%, about 20% to about 50%, about 20% to about 40%, about 20 to about 35%, about 20 to about 30%, about 20% to about 25%, about 25% to about 40%, about 25% to about 35%, about 25% to about 30%, about 30% to about 70%, about 30% to about 60%, about 30% to about 50%, about 30 to about 40%, about 30 to about 35%, about 35% to about 40% (w/w), and the like. In representative embodiments, an Admixture 132 is provided that comprises, consists essentially of, or consists of at least about 15% the FVNG-pomace to total protein (w/w). Therefore, in some embodiments, the Admixture 132 comprises, consists essentially of, or consists of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 127, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 194, 194, 195, 196, 197, 198, 199, 200 percent (w/w), or any value or range therein, for the ratio of the FVNG-pomace to total protein (dry weight).

In one embodiment, an Admixture 132 comprises a complex of one or more plant proteins and FVNG-pomace phenolics, wherein the percentage of plant proteins that are complexed with phenolics is about 5% to 100% m optionally at least about 5% of plant proteins are complexed. In some embodiments, the Admixture 132 comprises a complex of one or more plant proteins and FVNG-pomace phenolics, wherein the percentage of plant proteins that are complexed with phenolics consists essentially of, or consists of about 5% to about 100%, about 5% to about 90%, about 5% to about 80%, about 5% to about 70%, about 5% to about 60%, about 5% to about 50%, about 5% to about 90%, about 5% to about 80%, about 5% to about 70%, about 5% to about 60%, about 5% to about 50%, about 5% to about 40%, about 5% to about 35%, about 5% to about 30%, about 5% to about 25%, about 5% to about 20%, about 5% to about 15%, about 5% to about 10%, about 10% to about 70%, about 10% to about 60%, about 10% to about 50%, about 10% to about 40%, about 10% to about 35%, about 10% to about 30%, about 10% to about 25%, about 10% to about 20%, about 10% to about 15%, about 15% to about 70%, about 15% to about 60%, about 15% to about 50%, about 15% to about 40%, about 15% to about 35%, about 15% to about 30%, about 15% to about 25%, about 15% to about 20%, about 20% to about 70%, about 20% to about 60%, about 20% to about 50%, about 20% to about 40%, about 20 to about 35%, about 20 to about 30%, about 20% to about 25%, about 25% to about 40%, about 25% to about 35%, about 25% to about 30%, about 30% to about 70%, about 30% to about 60%, about 30% to about 50%, about 30 to about 40%, about 30 to about 35%, about 35% to about 40% the FVNG-pomace to total protein (w/w) and the like. In representative embodiments, an Admixture is provided that comprises a complex of one or more plant proteins and FVNG-pomace phenolics, wherein the percentage of plant proteins that are complexed with phenolics consists essentially of, or consists of at least about 15%. Therefore, in some embodiments, the Admixture comprises, consists essentially of, or consists of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent (w/w), or any value or range therein, for the percentage of plant proteins that are complexed with phenolics.

In one embodiment, a Base Substance 135 is provided comprising FVNG-pomace and one or more plant proteins, wherein the ratio of the FVNG-pomace to total protein consists of about 5% to 200% (dry w/w). In some embodiments, the Base Substance 135 comprises, consists essentially of, or consists of about 5% to about 200%, about 5% to about 190%, about 5% to about 180%, about 5% to about 140%, about 5% to about 130%, 5% to about 120%, about 5% to about 110%, about 5% to about 100%, about 5% to about 90%, about 5% to about 80%, about 5% to about 70%, about 5% to about 60%, about 5% to about 50%, about 5% to about 90%, about 5% to about 80%, about 5% to about 70%, about 5% to about 60%, about 5% to about 50%, about 5% to about 40%, about 5% to about 35%, about 5% to about 30%, about 5% to about 25%, about 5% to about 20%, about 5% to about 15%, about 5% to about 10%, about 10% to about 70%, about 10% to about 60%, about 10% to about 50%, about 10% to about 40%, about 10% to about 35%, about 10% to about 30%, about 10% to about 25%, about 10% to about 20%, about 10% to about 15%, about 15% to about 70%, about 15% to about 60%, about 15% to about 50%, about 15% to about 40%, about 15% to about 35%, about 15% to about 30%, about 15% to about 25%, about 15% to about 20%, about 20% to about 70%, about 20% to about 60%, about 20% to about 50%, about 20% to about 40%, about 20 to about 35%, about 20 to about 30%, about 20% to about 25%, about 25% to about 40%, about 25% to about 35%, about 25% to about 30%, about 30% to about 70%, about 30% to about 60%, about 30% to about 50%, about 30 to about 40%, about 30 to about 35%, about 35% to about 40% the FVNG-pomace to total protein (w/w) and the like. In representative embodiments, a Base Substance 135 is provided that comprises, consists essentially of, or consists of at least about 15% the FVNG-pomace to total protein (w/w). Therefore, in some embodiments, the Base Substance 135 comprises, consists essentially of, or consists of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 127, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 194, 194, 195, 196, 197, 198, 199, 200 percent (w/w), or any value or range therein, for the ratio of the FVNG-pomace to total protein (dry weight).

In one embodiment, a Base Substance 135 comprises a complex of one or more plant proteins and FVNG-pomace phenolics, wherein the percentage of plant proteins that are complexed with phenolics is about 5% to 100% m optionally at least about 5% of plant proteins are complexed. In some embodiments, the Base Substance 135 comprises a complex of one or more plant proteins and FVNG-pomace phenolics, wherein the percentage of plant proteins that are complexed with phenolics consists essentially of, or consists of about 5% to about 100%, about 5% to about 90%, about 5% to about 80%, about 5% to about 70%, about 5% to about 60%, about 5% to about 50%, about 5% to about 90%, about 5% to about 80%, about 5% to about 70%, about 5% to about 60%, about 5% to about 50%, about 5% to about 40%, about 5% to about 35%, about 5% to about 30%, about 5% to about 25%, about 5% to about 20%, about 5% to about 15%, about 5% to about 10%, about 10% to about 70%, about 10% to about 60%, about 10% to about 50%, about 10% to about 40%, about 10% to about 35%, about 10% to about 30%, about 10% to about 25%, about 10% to about 20%, about 10% to about 15%, about 15% to about 70%, about 15% to about 60%, about 15% to about 50%, about 15% to about 40%, about 15% to about 35%, about 15% to about 30%, about 15% to about 25%, about 15% to about 20%, about 20% to about 70%, about 20% to about 60%, about 20% to about 50%, about 20% to about 40%, about 20 to about 35%, about 20 to about 30%, about 20% to about 25%, about 25% to about 40%, about 25% to about 35%, about 25% to about 30%, about 30% to about 70%, about 30% to about 60%, about 30% to about 50%, about 30 to about 40%, about 30 to about 35%, about 35% to about 40% the FVNG-pomace to total protein (w/w) and the like. In representative embodiments, a Base Substance 135 is provided that comprises, comprises a complex of one or more plant proteins and FVNG-pomace phenolics, wherein the percentage of plant proteins that are complexed with phenolics consists essentially of, or consists of at least about 15%. Therefore, in some embodiments, the Base Substance 135 comprises, consists essentially of, or consists of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent (w/w), or any value or range therein, for the percentage of plant proteins that are complexed with phenolics.

In one embodiment, a Base Substance 135 or an Admixture 132 can be processed into a Meat Analogue 145 wherein the ratio of the FVNG-pomace to total protein consists essentially of, or consisting of about 5% to 200% (dry w/w). In some embodiments, the Meat Analogue 145 comprises, consists essentially of, or consists of about 5% to about 200%, about 5% to about 190%, about 5% to about 180%, about 5% to about 140%, about 5% to about 130%, 5% to about 120%, about 5% to about 110%, about 5% to about 100%, about 5% to about 90%, about 5% to about 80%, about 5% to about 70%, about 5% to about 60%, about 5% to about 50%, about 5% to about 90%, about 5% to about 80%, about 5% to about 70%, about 5% to about 60%, about 5% to about 50%, about 5% to about 40%, about 5% to about 35%, about 5% to about 30%, about 5% to about 25%, about 5% to about 20%, about 5% to about 15%, about 5% to about 10%, about 10% to about 70%, about 10% to about 60%, about 10% to about 50%, about 10% to about 40%, about 10% to about 35%, about 10% to about 30%, about 10% to about 25%, about 10% to about 20%, about 10% to about 15%, about 15% to about 70%, about 15% to about 60%, about 15% to about 50%, about 15% to about 40%, about 15% to about 35%, about 15% to about 30%, about 15% to about 25%, about 15% to about 20%, about 20% to about 70%, about 20% to about 60%, about 20% to about 50%, about 20% to about 40%, about 20 to about 35%, about 20 to about 30%, about 20% to about 25%, about 25% to about 40%, about 25% to about 35%, about 25% to about 30%, about 30% to about 70%, about 30% to about 60%, about 30% to about 50%, about 30 to about 40%, about 30 to about 35%, about 35% to about 40% the FVNG-pomace to total protein (w/w) and the like. In representative embodiments, a Meat Analogue 145 is provided that comprises, consists essentially of, or consists of at least about 15% the FVNG-pomace to total protein (w/w). Therefore, in some embodiments, the Meat Analogue 145 comprises, consists essentially of, or consists of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 127, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 194, 194, 195, 196, 197, 198, 199, 200 percent (w/w), or any value or range therein, for the ratio of the FVNG-pomace to total protein (dry weight).

In one embodiment, a Base Substance 135 or an Admixture 132 can be processed into a Meat Analogue 145 wherein the percentage of plant proteins that are complexed with phenolics is about 5% to 100% m optionally at least about 5% of plant proteins are complexed. In some embodiments, the Meat Analogue 145 comprises a complex of one or more plant proteins and FVNG-pomace phenolics, wherein the percentage of plant proteins that are complexed with phenolics consists essentially of, or consists of about 5% to about 100%, about 5% to about 90%, about 5% to about 80%, about 5% to about 70%, about 5% to about 60%, about 5% to about 50%, about 5% to about 90%, about 5% to about 80%, about 5% to about 70%, about 5% to about 60%, about 5% to about 50%, about 5% to about 40%, about 5% to about 35%, about 5% to about 30%, about 5% to about 25%, about 5% to about 20%, about 5% to about 15%, about 5% to about 10%, about 10% to about 70%, about 10% to about 60%, about 10% to about 50%, about 10% to about 40%, about 10% to about 35%, about 10% to about 30%, about 10% to about 25%, about 10% to about 20%, about 10% to about 15%, about 15% to about 70%, about 15% to about 60%, about 15% to about 50%, about 15% to about 40%, about 15% to about 35%, about 15% to about 30%, about 15% to about 25%, about 15% to about 20%, about 20% to about 70%, about 20% to about 60%, about 20% to about 50%, about 20% to about 40%, about 20 to about 35%, about 20 to about 30%, about 20% to about 25%, about 25% to about 40%, about 25% to about 35%, about 25% to about 30%, about 30% to about 70%, about 30% to about 60%, about 30% to about 50%, about 30 to about 40%, about 30 to about 35%, about 35% to about 40% the FVNG-pomace to total protein (w/w) and the like. In representative embodiments, a Meat Analogue 145 is provided that comprises, comprises a complex of one or more plant proteins and FVNG-pomace phenolics, wherein the percentage of plant proteins that are complexed with phenolics consists essentially of, or consists of at least about 15%. Therefore, in some embodiments, the Base Substance 135 comprises, consists essentially of, or consists of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent (w/w), or any value or range therein, for the percentage of plant proteins that are complexed with phenolics.

In one embodiment, a Meat Analogue 145 can be processed into a Final Product 155 wherein the ratio of the FVNG-pomace to total protein consists essentially of, or consisting of about 5% to 200% (dry w/w). In some embodiments, the Final Product 155 comprises, consists essentially of, or consists of about 5% to about 200%, about 5% to about 190%, about 5% to about 180%, about 5% to about 140%, about 5% to about 130%, 5% to about 120%, about 5% to about 110%, about 5% to about 100%, about 5% to about 90%, about 5% to about 80%, about 5% to about 70%, about 5% to about 60%, about 5% to about 50%, about 5% to about 90%, about 5% to about 80%, about 5% to about 70%, about 5% to about 60%, about 5% to about 50%, about 5% to about 40%, about 5% to about 35%, about 5% to about 30%, about 5% to about 25%, about 5% to about 20%, about 5% to about 15%, about 5% to about 10%, about 10% to about 70%, about 10% to about 60%, about 10% to about 50%, about 10% to about 40%, about 10% to about 35%, about 10% to about 30%, about 10% to about 25%, about 10% to about 20%, about 10% to about 15%, about 15% to about 70%, about 15% to about 60%, about 15% to about 50%, about 15% to about 40%, about 15% to about 35%, about 15% to about 30%, about 15% to about 25%, about 15% to about 20%, about 20% to about 70%, about 20% to about 60%, about 20% to about 50%, about 20% to about 40%, about 20 to about 35%, about 20 to about 30%, about 20% to about 25%, about 25% to about 40%, about 25% to about 35%, about 25% to about 30%, about 30% to about 70%, about 30% to about 60%, about 30% to about 50%, about 30 to about 40%, about 30 to about 35%, about 35% to about 40% the FVNG-pomace to total protein (w/w) and the like. In representative embodiments, a Final Product 155 is provided that comprises, consists essentially of, or consists of at least about 15% the FVNG-pomace to total protein (w/w). Therefore, in some embodiments, the Final Product 155 comprises, consists essentially of, or consists of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 127, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 194, 194, 195, 196, 197, 198, 199, 200 percent (w/w), or any value or range therein, for the ratio of the FVNG-pomace to total protein (dry weight).

In one embodiment, a Meat Analogue 145 can be processed into a Final Product 155 wherein the percentage of plant proteins that are complexed with phenolics is about 5% to 100% m optionally at least about 5% of plant proteins are complexed. In some embodiments, the Final Product 155 comprises a complex of one or more plant proteins and FVNG-pomace phenolics, wherein the percentage of plant proteins that are complexed with phenolics consists essentially of, or consists of about 5% to about 100%, about 5% to about 90%, about 5% to about 80%, about 5% to about 70%, about 5% to about 60%, about 5% to about 50%, about 5% to about 90%, about 5% to about 80%, about 5% to about 70%, about 5% to about 60%, about 5% to about 50%, about 5% to about 40%, about 5% to about 35%, about 5% to about 30%, about 5% to about 25%, about 5% to about 20%, about 5% to about 15%, about 5% to about 10%, about 10% to about 70%, about 10% to about 60%, about 10% to about 50%, about 10% to about 40%, about 10% to about 35%, about 10% to about 30%, about 10% to about 25%, about 10% to about 20%, about 10% to about 15%, about 15% to about 70%, about 15% to about 60%, about 15% to about 50%, about 15% to about 40%, about 15% to about 35%, about 15% to about 30%, about 15% to about 25%, about 15% to about 20%, about 20% to about 70%, about 20% to about 60%, about 20% to about 50%, about 20% to about 40%, about 20 to about 35%, about 20 to about 30%, about 20% to about 25%, about 25% to about 40%, about 25% to about 35%, about 25% to about 30%, about 30% to about 70%, about 30% to about 60%, about 30% to about 50%, about 30 to about 40%, about 30 to about 35%, about 35% to about 40% the FVNG-pomace to total protein (w/w) and the like. In representative embodiments, a Final Product 155 is provided that comprises, comprises a complex of one or more plant proteins and FVNG-pomace phenolics, wherein the percentage of plant proteins that are complexed with phenolics consists essentially of, or consists of at least about 15%. Therefore, in some embodiments, the Final Product 155 comprises, consists essentially of, or consists of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent (w/w), or any value or range therein, for the percentage of plant proteins that are complexed with phenolics.

In one embodiment, a Final Product 155 can be processed into a Cooked Final Product 165 In one embodiment, a Final Product 155 can be processed into a Cooked Final Product 165 wherein the ratio of the FVNG-pomace to total protein consists essentially of, or consisting of about 5% to 200% (dry w/w). In some embodiments, the Cooked Final Product 165 comprises, consists essentially of, or consists of about 5% to about 200%, about 5% to about 190%, about 5% to about 180%, about 5% to about 140%, about 5% to about 130%, 5% to about 120%, about 5% to about 110%, about 5% to about 100%, about 5% to about 90%, about 5% to about 80%, about 5% to about 70%, about 5% to about 60%, about 5% to about 50%, about 5% to about 90%, about 5% to about 80%, about 5% to about 70%, about 5% to about 60%, about 5% to about 50%, about 5% to about 40%, about 5% to about 35%, about 5% to about 30%, about 5% to about 25%, about 5% to about 20%, about 5% to about 15%, about 5% to about 10%, about 10% to about 70%, about 10% to about 60%, about 10% to about 50%, about 10% to about 40%, about 10% to about 35%, about 10% to about 30%, about 10% to about 25%, about 10% to about 20%, about 10% to about 15%, about 15% to about 70%, about 15% to about 60%, about 15% to about 50%, about 15% to about 40%, about 15% to about 35%, about 15% to about 30%, about 15% to about 25%, about 15% to about 20%, about 20% to about 70%, about 20% to about 60%, about 20% to about 50%, about 20% to about 40%, about 20 to about 35%, about 20 to about 30%, about 20% to about 25%, about 25% to about 40%, about 25% to about 35%, about 25% to about 30%, about 30% to about 70%, about 30% to about 60%, about 30% to about 50%, about 30 to about 40%, about 30 to about 35%, about 35% to about 40% the FVNG-pomace to total protein (w/w) and the like. In representative embodiments, a Cooked Final Product 165 is provided that comprises, consists essentially of, or consists of at least about 15% the FVNG-pomace to total protein (w/w). Therefore, in some embodiments, the Cooked Final Product 165 comprises, consists essentially of, or consists of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 127, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 194, 194, 195, 196, 197, 198, 199, 200 percent (w/w), or any value or range therein, for the ratio of the FVNG-pomace to total protein (dry weight).

In one embodiment, a Final Product 155 can be processed into a Cooked Final Product 165 wherein the percentage of plant proteins that are complexed with phenolics is about 5% to 100% m optionally at least about 5% of plant proteins are complexed. In some embodiments, the Cooked Final Product 165 comprises a complex of one or more plant proteins and FVNG-pomace phenolics, wherein the percentage of plant proteins that are complexed with phenolics consists essentially of, or consists of about 5% to about 100%, about 5% to about 90%, about 5% to about 80%, about 5% to about 70%, about 5% to about 60%, about 5% to about 50%, about 5% to about 90%, about 5% to about 80%, about 5% to about 70%, about 5% to about 60%, about 5% to about 50%, about 5% to about 40%, about 5% to about 35%, about 5% to about 30%, about 5% to about 25%, about 5% to about 20%, about 5% to about 15%, about 5% to about 10%, about 10% to about 70%, about 10% to about 60%, about 10% to about 50%, about 10% to about 40%, about 10% to about 35%, about 10% to about 30%, about 10% to about 25%, about 10% to about 20%, about 10% to about 15%, about 15% to about 70%, about 15% to about 60%, about 15% to about 50%, about 15% to about 40%, about 15% to about 35%, about 15% to about 30%, about 15% to about 25%, about 15% to about 20%, about 20% to about 70%, about 20% to about 60%, about 20% to about 50%, about 20% to about 40%, about 20 to about 35%, about 20 to about 30%, about 20% to about 25%, about 25% to about 40%, about 25% to about 35%, about 25% to about 30%, about 30% to about 70%, about 30% to about 60%, about 30% to about 50%, about 30 to about 40%, about 30 to about 35%, about 35% to about 40% the FVNG-pomace to total protein (w/w) and the like. In representative embodiments, a Cooked Final Product 165 is provided that comprises, comprises a complex of one or more plant proteins and FVNG-pomace phenolics, wherein the percentage of plant proteins that are complexed with phenolics consists essentially of, or consists of at least about 15%. Therefore, in some embodiments, the Cooked Final Product 165 comprises, consists essentially of, or consists of at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 percent (w/w), or any value or range therein, for the percentage of plant proteins that are complexed with phenolics.

Step 1A: Optionally Prepare One or More Sources of Plant Protein

In Step 1A 110, according to one embodiment, there is an optional step of processing one or more sources of plant protein 102 in order to provide a source of one or more plant proteins. In one embodiment, this source of plant protein can be a form of plant-based agricultural waste, residue, by-product or side-stream. In one embodiment, the source of plant protein can be a company that sells plant protein, for example, a source such as Puris™ (Turtle Lake, Wis., US).

Possible sources of plant proteins can be obtained from plants and/or agricultural waste, residues, by-product or side-stream including alfalfa, almond, bamboo, barley, beets, bean, black beans, broad bean, broccoli, buckwheat, cabbage, canola, carrot, carob, cauliflower, celery, celery root, celery, chickpeas, clover, cocoa, corn, cotton, cow peas, earth pea, pigeon pea, sweet pea, fava beans, flax, fonio, garbanzo beans, gluten, green beans, hemp, kale, kidney beans, legume, lentil, lupin, maize, mung beans, navy beans, nut, mesquite, northern beans, nuts, oats, parsley, pearl millet, oat, peanut, peas, pine nuts, pinto beans, potato, pulses, quinoa, red beans, rice, rye, sesame, sorghum, soybean, spelt, sugarbeet, sunflowers, sweet potato, tobacco, tricale, wheat, wheat gluten, white beans, whole grains, wild rice, zucchini, fungal, algal, seaweed protein, or seeds of plants of the genus Vicia, Phaseolus, Vigna, Cicer, Pisum, Lathyrus, Lens, Lablab, Glycine, Psophocarpus, Mucuna, Cyamopsis, Canavalia, Macrotyloma, Lupinus, or Arachisa, a protein concentrate thereof, a protein isolate thereof, a hydrolysate thereof, or any combination of any two or more thereof or a mixture thereof.

In one embodiment, the one or more plant proteins are prepared for forming complexes with the phenolics within the one or more Sources of Phenolics. There are a number of different ways that are well known for how the one or more plant proteins 102 could be processed, for example options comprise grinding, fermentation, addition of exogenous amylase, heating, modification of pH, ionic modification, or any process or processes that alter water activity. In one embodiment, the processing includes partial or complete denaturation of the plant proteins prior to combining 130 with the one or more FVNG-pomace 104.

In Step 1A 110 sources of one or more appropriate plant proteins 102 are selected and prepared in a manner to facilitate the formation of complexes between protein and phenolics in the FVNG-pomace. Depending on the characteristics of the Final Product 155 and the type of meat it is seeking to replicate, different sources of plant protein 102 will be desired. In one embodiment, one type of plant protein will be used. In one embodiment, two types of plant protein 102 will be used. In one embodiment three or more types of plant protein 102 will be used. In one embodiment four or more plant protein 102 will be used. In one embodiment, a proprietary blend of proteins will be used.

One skilled in the art will appreciate that different sources of plant protein 102 will contain different levels of protein, starch, oils, fiber, amino acid profile, flavor profile, availability, cost, etc.

The one or more plant proteins 102 may comprise comminuted plant material, such as comminuted vegetable, fruit, or cereal material, a slurry, or a powder. (Comminution is the reduction of solid materials from one average particle size to a smaller average particle size, by crushing, grinding, cutting, sonication, vibrating, or other processes). The powder may be a non-agglomerated, agglomerated, roll-compacted, lyophilised, drum dried, freeze dried, spray dried or foam spray dried powder. The powder may comprise whole tissue, a protein concentrate, or protein isolate.

A whole tissue protein powder, a protein concentrate powder, or a protein isolate powder may comprise at least about 10, 15, 20, 25, 30, 35, 40, 45, 50, 55, 60, 65, 70, 75, 80, 85, 90, 95, 99, or 100% protein by weight, and useful ranges may be selected between any of these values (for example about 10 to about 100, about 20 to about 100, about 30 to about 100, about 40 to about 100, about 50 to about 100, about 60 to about 100, about 70 to about 100, or about 80 to about 100%).

In general, if the source of plant protein is dry (e.g., pea) and non-oily, the protein can optionally be dry milled to create smaller particle sizes. If a protein source is oily, such as peanuts, then there may be a defatting step incorporated into preparing the source of plant protein.

The process and methods herein are demonstrated and described with reference to pea protein, but not in any way limited to pea protein.

In one embodiment, the product of this invention comprises a pea protein. As used herein, “pea” means the mostly small spherical seed of the pod fruit Pisum sativum. In one embodiment, however, the pea in the pod may be used, to incorporate pea fibers from the pod into the Base Substance 135.

The pea used in this embodiment is from varieties of the species typically called field peas or yellow peas that are grown to produce dry peas that are shelled from the mature pod. Though traditionally a cool-season crop, new varieties have been bred that can be grown in hotter climates and also in dryer climates. Peas also have been generally bred to contain higher contents of protein.

The pea protein material according to one embodiment includes at least 70% dry weight protein, preferably at least 80% dry weight. The product of this invention is not limited by the specific protein content of the peas used in the production of the pea protein material of this invention. A large number of pea varieties are available to the producer and each has its own protein content percentage. Pea protein (as traditionally grown, harvested, and ground) has an isoelectric point of about pH 4.5. The isoelectric point is the pH at which particular molecule carries no net electrical the statistical mean. This means that the pea proteins (which are mostly globulins) have a minimum solubility near the isoelectric point of pH 4.5 and a high solubility above and a moderate solubility below pH 4.5.

Proteins are made up of a bundle of molecules of different lengths, each molecule having charges and reactive points along their lengths. This charged and reactive state is what allows proteins to absorb water and to be water soluble. As protein is not charged at its isoelectric point of pH 4.5, protein is least reactive with water at pH 4.5.

The protein in peas comprises many individual proteins of various molecular weights. Though the majority of the proteins are globulins, even they are of a range of molecular weight molecules. To make pea protein more soluble, it can be treated in such a way as to break some of those protein molecules into smaller molecules (i.e., smaller molecules having smaller molecular weights), exposing more charged and reactive sites for interaction with water molecules. This is commonly called hydrolyzing the protein. The resulting hydrolyzed proteins are commonly called protein hydrolysates. In one embodiment, the process comprises the addition of one or more exogenous proteases such as bromelin or papain.

In one embodiment, wherein the focus is only pea protein, producing at least 70% dry weight protein pea protein intermediate slurry from peas can be done by several different processes known by those who practice in this art. The specific method chosen does not limit the scope of this invention. In one embodiment, the process includes reducing the pea-in-the-pod into particles that can then be separated into fiber, starch, and protein portions. One method of such separation is to grind the dry pea, and use a series of air classification steps to remove the less dense fiber and starch, and to leave behind an intermediate pea protein material that has at least 70% dry weight protein content. A second method of separation is to grind the pea to only remove the hull, then grind the remaining pea material with enough water to create an intermediate stage slurry, and finally separate the insoluble fiber and starch portions from the intermediate stage slurry to create a pea protein intermediate slurry containing the soluble protein portion. Separation of pea protein from the intermediate stage slurry in this second method can be accomplished by various separation techniques. These techniques include, but are not limited to, decanters, centrifuges, clarifiers, and hydro cyclones. The pea protein intermediate slurry containing at least 70% dry weight protein can be formed by removing water through various separation techniques including, but not limited to, decanters, centrifuges, clarifiers, ovens, spray dryers, fluid bed dryers, freeze driers, vacuum filtration, tamgential filtration, and drum dryers.

Step 1B: Prepare the One or More Sources of Phenolics (PVNG-Pomace)

Any polyphenol rich plant (e.g., fruit, vegetable, nut or grain) can be used with this invention. In some embodiments, any polyphenol rich fruit, vegetable, nut or grain that is commercially juiced or pressed to expel oil can be used. For example, any type of berry may be used with this invention. Non-limiting examples of plants useable as a FVNG-pomace can be black currant, blueberry, cranberry, lingnonberry, cherry, grape, muscadine, pomegranate, blackberry, green tea (Camellia spp.), cinnamon, aronia, Sorbaronia mitschurinii, citrus, and/or peanut (e.g., peanut skins). In some embodiments, a fermented fruit product can be from a plant including, but not limited to, black currant, blueberry, cranberry, lingnonberry, cherry, grape, muscadine, blackberry, green tea (Camellia spp.), cinnamon, aronia, Sorbaronia mitschurinii, citrus, peanut (e.g., peanut skins), or any combination thereof.

In one embodiment, low sugar or sugar free plant tissue comprises, consists essentially of, or consists of a pomace and/or a fermented fruit product. In general, in the industry, pomace means the pulpy tissue remaining after fruit and/or other plant material, including seeds, leaves, etc., has been crushed in order to extract the juice or oil. Any polyphenol rich fruit, vegetable, nut or grain that is commercially juiced or pressed can be used, including but not limited to any type of berry. In some embodiments, a pomace can be from a plant including, but not limited to, apple, pomegranate, black currant, blueberry, cranberry, lingnonberry, cherry, grape, muscadine, blackberry, chokecherry (aroma), cinnamon, Sorbaronia mitschurinii, Camellia spp. (tea) (e.g., Camellia sinensis, Camellia oleifera), and/or peanut (Arachis hypogaea) (e.g., peanut skins).

Possible sources of phenolics can be obtained from plants and/or agricultural waste or residues, including, but not limited to alfalfa, almond, bamboo, barley, beets, bean, black beans, broad bean, broccoli, buckwheat, cabbage, canola, carrot, carob, cauliflower, celery, celery root, celery, chickpeas, clover, cocoa, corn, cotton, cow peas, earth pea, pigeon pea, sweet pea, fava beans, flax, fonio, garbanzo beans, green beans, hemp, kale, kidney beans, legume, lentil, lupin, maize, mung beans, navy beans, nut, mesquite, northern beans, nuts, oats, parsley, pearl millet, oat, peanut, peas, pine nuts, pinto beans, potato, pulses, quinoa, red beans, rice, rye, sesame, sorghum, soybean, spelt, sugarbeet, sunflowers, sweet potato, tobacco, tricale, wheat, wheat gluten, white beans, whole grains, wild rice, zucchini, fungal, algal, seaweed protein, or seeds of plants of the genus Vicia, Phaseolus, Vigna, Cicer, Pisum, Lathyrus, Lens, Lablab, Glycine, Psophocarpus, Mucuna, Cyamopsis, Canavalia, Macrotyloma, Lupinus, or Arachisa, a phenolics concentrate thereof, a phenolics thereof, or any combination of any two or more thereof or a mixture thereof.

In one embodiment, the one or more FVNG-pomace 104 comprise, consist essentially of, or consist of pomace, or wine derivatives (pomace, with or without lees). In one embodiment the FVNG-pomace 104 comprises fruit, vegetable, nut or grain-pomace (“FVNG-pomace”). In one embodiment, the FVNG-pomace 104 comprises wine-pomace from wine derivatives (grape and/or other fruits and berries). In one embodiment, the FVNG-pomace 104 comprises wine derivatives including lees.

When the derivatives to be used in accordance with the invention include lees, they are rich in phenolics and proteins from the yeasts used, particularly when egg white or other proteinaceous type of fining agent has been added to the wine for fining, and contain these phenolics and proteins predominantly in the form of association complexes. In one embodiment, the derivatives from winemaking contain association complexes of phenolics and proteins. One type of the association complexes can be formed when the phenolics are attached to the cell wall of the yeast by the mannoproteins present.

In Step 1B 120 the wine derivatives (FVNG-pomace) are processed in order to prepare them for forming complexes with the protein obtained from the processed protein plant sources. There are a number of well known different ways that the one or more FVNG-pomace 104 could be processed, for example options comprise grinding, fermentation, addition of exogenous phenolics, heating, addition of lees,

In one embodiment, pomace and/or wine derivatives are ground into small particles or a meal. Depending on how hard the berries have been pressed, it may be desirable to add some water to re-hydrate the pressed berries allowing them to swell, prior to grinding.

In one embodiment, the meal can be inoculated and fermented prior to combining with the processed plant protein. In one embodiment, the meal is combined with the plant protein combining with the processed plant protein.

In one embodiment, exogenous tannins can be added to the one or more FVNG-pomace 104. In one embodiment, exogenous phenolics can be added to the one or more FVNG-pomace 104.

Step 1C; Generate Protein-Polyphenol Complexes

Under oxidative conditions, at or near physiological pH and with or without enzymatic catalysis, phenols are readily transformed to quinones which may then interact irreversibly with nucleophilic groups (e.g., SH, NH2) on a protein molecule via covalent bonding. Furthermore, by increasing the ratio of phenolics to proteins in the process of producing the protein-polyphenol complexes, the formation of irreversible bonds between the protein and phenolics is favored.

In one embodiment, the generation of protein-polyphenol complexes includes partial or complete denaturation of the plant proteins after combining 130 with the one or more FVNG-pomace 104. Denaturation of the composition can be accomplished by a number of different methods including, but not limited to: altering the temperature; pH; ionic strength; adding proteolytic enzymes.

Modification Steps

There are a number of ways to modify the characteristics of the Admixture 132 or Base Substance 135. Some examples are provided herein, in no particular order. The Modification Steps, comprise: fermentation, heating, incorporation of various additives. Examples of additives comprise: lees, enzymes, phenolics, carbohydrates, starch, gum, hydrocolloid, plant-based fibers, fungal mycelium, flavor precursors, fat, lactones, and protein-binding agents, etc.

In one embodiment, acidification is a Modification Step. There are a number of well-known methods for effecting this change.

Fermentation

Fermentation is a process in which an agent, such as a fungus and/or a bacterium, causes an organic substance to break down into simpler substances; and includes the anaerobic breakdown of sugar into alcohol

Lactic Acid Bacteria

Lactic acid bacteria (LAB) are an order of gram-positive, acid-tolerant, generally nonsporulating, non-respiring, either rod-shaped (bacilli) or spherical (cocci) bacteria that belong to the order Lactobacillales and share common metabolic and physiological characteristics. Lactic acid bacteria are used in the food industry for a variety of reasons such as the production of cheese and yogurt nutrient-rich products. The genera that comprise the LAB are at its core Lactobacillus, Leuconostoc, Pediococcus, Lactococcus, and Streptococcus, as well as the more peripheral Aerococcus, Carnobacterium, Enterococcus, Oenococcus, Sporolactobacillus, Tetragenococcus, Vagococcus, and Weissella.

Acetic Acid Bacteria

One skilled in the art of fermentation would know which one(s) to select from the family of family Acetobacteraceae.

Acetic acid bacteria (AAB) are a group of rod-shaped, Gram-negative bacteria which aerobically oxidize sugars, sugar alcohols, or ethanol with the production of acetic acid as the major end nutrient-rich product. This special type of metabolism differentiates them from all other bacteria. The acetic acid bacteria consist of 10 genera in the family Acetobacteraceae, including Acetobacter. Species of Acetobacter include: A. aceti; A. cerevisiae; A. cibinongensis; A. estunensis; A. fabarum; A. farinahs; A. indonesiensis; A. lambici; A. liquefaciens; A. lovaniensis; A. malorum; A. musti; A. nitrogenifigens; A. oeni; A. okinawensis; A. orientalis; A. orleanensis; A. papaya; A. pasteurianus; A. peroxydans; A. persici; A. pomorum; A. senegalensis; A. sicerae; A. suratthaniensis; A. syzygii; A. thailandicus; A. tropicalis; and A. xylinus. Several species of acetic acid bacteria are used in industry for production of certain foods and chemicals.

The strains, which have been identified include: Acidibrevibacterium Acidicaldus Acidiphihum Acidisoma Acidisphaera Acidocella Acidomonas Ameyamaea Asaia Belnapia Bombella Caldovatus Commensahbacter Craurococcus Crenalkalicoccus; Dankookia Elioraea Endobacter Gluconacetobacter; Gluconobacter Granulibacter Humitalea Komagatabacter Komagataeibacter Kozakia Muricoccus Neoasaia Neokomagataea Nguyenibacter Paracraurococcus; Parasaccharibacter. Although a variety of bacteria can produce acetic acid, mostly members of Acetobacter, Gluconacetobacter, and Gluconobacter are used commercially. One skilled in the art would know which one(s) to choose for the fermentation processes depending on the final nutrient-rich product they desire to generate.

Yeasts

Exemplary yeasts includes, but are not limited to Saccharomyces sp. (for example, from the genus Saccharomyces arboricolus, Saccharomyces eubayanus, Saccharomyces bayanus, Saccharomyces beticus, Saccharomyces cerevisiae, Saccharomyces fermentati, Saccharomyces kudriadzevii, Saccharomyces mikatae, Saccharomyces paradoxus, Saccharomyces pastorianus and Saccharomyces uvarum), Brettanomyces sp. (Teleomorph Dekkera sp), Candida (Teleomorphs for different species from several genera including Pichia sp., Metschnikowia sp., Issatchenkia sp., Torulaspora sp. and Kluyveromyces sp), Kloeckera sp. (Teleomorph Hanseniaspora sp), Saccharomycodes sp., Schizosaccharomyces sp. Yarrowia sp. (Yarrowia lipolytica) and Zygosaccharomyces sp. One exemplary strain is Saccharomyces cerevisiae, var. diastaticus.

In embodiments, the yeast cells can be from Saccharomyces sp., Brettanomyces sp., Candida, Kloeckera sp., Saccharomycodes sp., Schizosaccharomyces sp., Yarrowia sp. or Zygosaccharomyces sp. In still embodiments, the yeast cells are selected from the group consisting of Saccharomyces sp., Brettanomyces sp., Candida, Kloeckera sp., Saccharomycodes sp., Schizosaccharomyces sp., Yarrowia sp. and Zygosaccharomyces sp.

In embodiments, the yeast cells can be a Saccharomyces arboricolus, a Saccharomyces eubayanus, a Saccharomyces bayanus, a Saccharomyces beticus, a Saccharomyces cerevisiae, a Saccharomyces fermentati, a Saccharomyces kudriadzevii, a Saccharomyces mikatae, a Saccharomyces paradoxus, a Saccharomyces pastorianus or Saccharomyces uvarum. In further embodiments, the yeast cells are selected from the group consisting of Saccharomyces arboricolus, Saccharomyces eubayanus, Saccharomyces bayanus, Saccharomyces beticus, Saccharomyces cerevisiae, Saccharomyces fermentati, Saccharomyces kudriadzevii, Saccharomyces mikatae, Saccharomyces paradoxus, Saccharomyces pastorianus and Saccharomyces uvarum. In further embodiments, the yeast cells are a Saccharomyces cerevisiae.

In embodiments, the yeast cells can be from Dekkera sp. In still embodiments, the yeast cells can be from Pichia sp., Metschnikowia sp., Issatchenkia sp., Torulaspora sp. or Kluyveromyces sp. In yet further embodiments, the yeast cells are selected from the group consisting of Pichia sp., Metschnikowia sp., Issatchenkia sp., Torulaspora sp. and Kluyveromyces sp. In embodiments, the yeast cells can be from Hanseniaspora sp. In further embodiments, the yeast cells can be from Yarrowia sp. In still a further embodiment, the yeast cells can be a Yarrowia lipolytica.

Heating the Base Substance

While it has been observed that phenolics can be protected to some degree from degradation due to high temperatures by complexation of phenolics to protein, as in the present process, as would be understood by the skilled artisan, too much heat can destroy phenolics. Thus, the range of time for heating will depend on the temperature used. Thus, higher temperatures can be used for shorter times and conversely, lower temperatures can be used with longer extraction times (i.e., time is inversely proportional to temperature).

Additives

FIG. 1 illustrate that at 140 one can conduct one or more Modification Steps which can include the inclusion of additives. Optionally additives are incorporated into the Base Substance 135 to add additional characteristics to the food product in accordance with its intended final application as a food product.

Exogenous Enzymes

In one embodiment, one or more exogenous enzymes are added. One skilled in the art would appreciate that there are a number of exogenous enzymes that can be added in order to effect a desired change. For example, proteases, hydrolyases (e.g., bromelin and papain), amylase, etc.

In one embodiment, transglutaminase is added.

Exogenous Phenolics

In one embodiment, one or more exogenous phenolics are added. These can be derived from one or more sources such as grape phenolic compounds extracted from seeds or skins, other fruit or vegetable phenolic compounds, or phenolic compounds extracted from wood, such as oak or acacia.

Carbohydrate Additives

In various embodiments, the one or more sources of carbohydrate may comprise, consist essentially of, or consist of plant carbohydrate, plant carbohydrate powder, plant polysaccharide, plant polysaccharide powder, pectin, pectin powder, fruit, fruit powder, fruit pectin powder, Cucurbitaceae fruit, Solanaceae fruit, Cucurbitaceae fruit powder, Solanaceae fruit powder, Cucurbitaceae fruit pectin powder, Solanaceae fruit pectin powder, chia seed extract, a sugar such as glucose, fructose or sucrose. or any combination of any two or more

In various embodiments the fruit may comprise, consist essentially of, or consist of one or more of whole fruit, peeled or skinned fruit, seedless or seed-free fruit, or fruit flesh, or any combination of any two or more thereof.

In various embodiments the fruit may comprise, consist essentially of, or consist of fresh, dried, comminuted, slurried, or powdered fruit, or any combination of any two or more thereof. The powder may comprise a fruit concentrate, isolate, and/or hydrolysate. The powder may be a non-agglomerated, agglomerated, roll-compacted, lyophilised, drum dried, spray dried or foam spray dried powder.

In various embodiments the fruit may comprise, consist essentially of, or consist of one or more true berry fruits, one or more Cucurbitaceae fruits, one or more Solanaceae fruits, one or more Solanoideae fruits, one or more citrus fruits, one or more aggregate fruits, one or more multiple fruits, one or more accessory fruits, or any combination of any two or more thereof.

Starch Additives

Starch is a carbohydrate polymer. Starches are comprised of amylose and amylopectin and arc typically in the form of granules. Amylopectin is the major component (about 70-80%) of most starches. It is found in the outer portion of starch granules and is a branched polymer of several thousand to several hundred thousand glucose units. Amylose is the minor component (about 20-30%) of most starches (there are high amylose starches with 50 to 70% amylose). It is found in the inner portion of starch granules and is a linear glucose polymer of several hundred to several thousand glucose units.

Sources of starch include but are not limited to fruits, seeds, and rhizomes or tubers of plants. Common sources of starch include but are not limited to rice, wheat, corn, potatoes, tapioca, arrowroot, buckwheat, banana, barley, cassava, kudzu, oca, sago, sorghum, sweet potatoes, taro and yams. Edible beans, such as favas, lentils and peas, are also rich in starch.

Some starches are classified as waxy starches. A waxy starch contains high amounts of amylopectin with very little amylose. Common waxy starches include waxy maize starch, waxy rice starch, and waxy wheat starch.

A modified starch is one that has been altered from its native state, resulting in modification of one or more of its chemical or physical properties. Starches may be modified, for example, by enzymes, oxidation or, substitution with various compounds. Starches can be modified to increase stability against heat, acids, or freezing, improved texture, increase or decrease viscosity, increase or decrease gelatinization times, and increase or decrease solubility, among others. Modified starches may be partially or completely degraded into shorter chains or glucose molecules. Amylopectin may be debranched. Starches that are modified by substitution have a different chemical composition. An OSA starch is a modified starch that has been partially substituted with n-octenyl succinic anhydride.

In various embodiments, the Admixture 132, Base Substance 135, Meat Analogue 145, etc., may comprise, consist essentially of, or consist of about 1, 2, 3, 4, 5, 6, 7, 8, 9, or 10% by weight on a dry basis of one or more food grade starches, and useful ranges may be selected between any of these values (for example, about 1 to about 10, about 2 to about 10, about 3 to about 10, about 3 to about 8%).

Gum Additives

In various embodiments the Admixture 132, Base Substance 135, Meat Analogue 145, etc., may further comprise, consist essentially of, or consist of one or more gums such as a plant gum. In various embodiments the gum may be selected from the group comprising xanthan gum, agar, alginate, cassia, dammar, pectin, beta-glucan, glucomannan, mastic, chicle, psyllium, spruce gum, gellan gum, acacia gum, guar gum, locust bean gum, carrageenans, gum arabic, karaya gum, ghatti gum, tragacanth gum, konjac gum, tara gum, pullulan, chia seed gum, fatted chia gum (FCG), or partially defatted chia gum (PDCG), or any combination of any two or more thereof.

In various embodiments, the Admixture 132, Base Substance 135, Meat Analogue 145, etc., may further comprise, consist essentially of, or consist of about 1, 2, 3, 4, 5, 6, 7, 8, 9, or 10% by weight on a dry basis of one or more gums, and useful ranges may be selected between any of these values (for example, about 1 to about 10, about 2 to about 10, about 3 to about 10, about 3 to about 8%).

Hydrocolloid Additives

Hydrocolloids are a family of long chain water soluble polysaccharides and are generally carbohydrate based which affect the viscosity/gelling of aqueous solutions. Common examples are locust bean gum, carrageenan (seaweed extract), guar gum, xanthan gum, gellan gum, scleroglucan, agar, pectin, alginate, cellulose derivatives, and gum acacia. These are broadly classified as gums. Starches and gelatin are sometimes characterized as hydrocolloids. One skilled in the art can use combinations of starches, gelatin, and gums to achieve desired texture and melt properties.

Oil from plant source(s): A lipid material composed of a mixture of generally triacylglycerides from non-animal sources such as soya, olive, rapeseed, avocado, palm, palm kernel, coconut, cocoa, peanut, corn, flax, sunflower, safflower, and cottonseed and seeds, which are typically high in oils (for e.g., grape seeds have about 20% fat/lipid/oil and hemp seeds, which have a high quality protein, in addition to a good fat.). These lipids may be solid or liquid at room temperature depending on the chain lengths of the fatty acids, degree of saturation, and method of hydrogenation. Oils from multiple sources may be combined or certain fractions removed by processing such as winterization.

In one embodiment, a lipid blend that is solid at room temperature, melting at 50° C. to 100° C. is incorporated as a Modification Step.

In one embodiment, a bacterium, such as Xanthomonaw is added to thicken the texture to provide xanthan. In one embodiment, the lactic acid spp. Gluconobacter is added to produces viscosity.

Plant-Based Fibers

Konjac is a large East Asian flowering plant, which is high in fiber that has been used in Asia to make certain food products. In one embodiment, konjac is used as a binding agent for textured plant protein.

Fungal Mycelium

Mycelium is the vegetative part of a fungus or fungus-like bacterial colony, consisting of a mass of branching, thread-like hyphae. Mushrooms, the fruit of Mycelium, have been revered for thousands of years by practitioners of traditional Asian medicine. Mycelium is the primary source of the beneficial properties of mushrooms. Classical fungi produce spore-bearing mushrooms and or vegetative mycelium which contain pharmacologically active metabolites including polysaccharides, glycoproteins, enzymes, triterpenes, phenols and sterols.

Fungi are adept at converting raw inputs into a range of components and compositions. Fungi are composed primarily of a cell wall that is constantly being extended at the tips of the hyphae. Unlike the cell wall of a plant, which is composed primarily of cellulose, or the structural component of an animal cell, which relies on collagen, the structural oligosaccharides of the cell wall of fungi relay primarily on chitin. Chitin is already used within multiple industries as a purified substance, including food additives for stabilization, binders in fabrics and adhesives, and medicinal applications.

The fungal mycelium can include fungi from Ascomycota and Zygomycota, including the genera Aspergillus, Fusarium, Neurospora, and Monascus. Other species include edible varieties of Basidiomycota and genera Lentinula. One genus is Neurospora, which is used in food production through solid fermentation. The genus of Neurospora are known for highly efficient biomass production as well as ability to break down complex carbohydrates. For certain species of Neurospora, no known allergies have been detected and no levels of mycotoxins are produced. In addition to monocultures of filamentous fungi, multiple strains can be cultivated at once to tune the protein, amino acid, mineral, texture, and flavor profiles of the final biomass.

In one embodiment, mycelium or spores of a selected fungal strain are added to the Base Substance in order improve the characteristics of the Final Product.

Flavor Precursors

In any of the methods or compositions described herein, wherein the one or more flavor precursors can be a sugar, a sugar alcohol, a sugar acid, a sugar derivative, an oil, a free fatty acid, an amino acid or derivative thereof, a nucleoside, a nucleotide, a vitamin, an acid, a peptide, a phospholipid, a protein hydrolysate, a yeast extract, or a mixture thereof. For example, the flavor precursor can be selected from the group consisting of glucose, fructose, ribose, arabinose, glucose-6-phosphate, fructose 6-phosphate, fructose 1,6-diphosphate, inositol, maltose, sucrose, maltodextrin, glycogen, nucleotide-bound sugars, molasses, a phospholipid, a lecithin, inosine, inosine monophosphate (IMP), guanosine monophosphate (GMP), pyrazine, adenosine monophosphate (AMP), lactic acid, succinic acid, glycolic acid, thiamine, creatine, pyrophosphate, vegetable oil, algal oil, sunflower oil, corn oil, soybean oil, palm fruit oil, palm kernel oil, safflower oil, flaxseed oil, rice bran oil, cottonseed oil, olive oil, sunflower oil, canola oil, flaxseed oil, coconut oil, mango oil, a free fatty acid, cysteine, methionine, isoleucine, leucine, lysine, phenylalanine, threonine, tryptophan, valine, arginine, histidine, alanine, asparagine, aspartate, glutamate, glutamine, glycine, proline, serine, tyrosine, glutathione, an amino acid derivative, urea, pantothenic acid, ornithine, niacin, glycerol, citrulline, taurine, biotin, borage oil, fungal oil, blackcurrant oil, betaine, beta carotene, B-vitamins, N-Acetyl L-cysteine, iron glutamate and a peptone, or mixtures thereof.

Fat Additives

In various embodiments the one or more sources of lipid may comprise, consist essentially of, or consist of one or more plant oils, one or more animal oils, one or more marine oils, or one or more algal oils, or one or more extracts thereof, or one or more hydrolysates thereof, or any combination of any two or more thereof.

In various embodiments the one or more sources of lipid may comprise, consist essentially of, or consist of a plant fat or oil, such as coconut, corn, cottonseed, canola, rapeseed, olive, palm, peanut, ground nut, safflower, sesame, soybean, sunflower, nut, hazelnut, almond, cashew, macadamia, pecan, pistachio, walnut, melon seed, gourd seed, bottle gourd, buffalo gourd, pumpkin seed, watermelon seed, acai, blackcurrant seed, borage seed, evening primrose, carob seed, amaranth, apricot, argan, artichoke, avocado, babassu, ben, borneo tallow nut, cohune, coriander seed, flax, flax seed, coriander seeds, grape seed, hemp, kapok seed, kiwifruit, lallemantia, meadowfoam seed, linseed, mustard, okra seed, perilla seed, pequi, pine nut, poppyseed, prune kernel, quinoa, ramtil, rice bran, tea, or wheat germ oil, or any combination of any two or more thereof.

In various embodiments a marine oil may comprise, consist essentially of, or consist of shellfish, fish, or marine algal oil, or any combination of any two or more thereof. In one embodiment the fish is selected from anchovy, baikal, bloater, cacha, carp, eel, eulachon, herring, Hoki, hilsa, jack fish, katla, kipper, mackerel, orange roughy, pangas, pilchard, black cod, salmon, sardine, shark, sprat, trout, tuna, whitebait, or swordfish, or any combination of any two or more thereof.

In any of the methods or compositions described herein, the fat can be a non-animal fat, an animal fat, or a mixture of non-animal and animal fat. The fat can be an algal oil, a fungal oil, corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut oil, babassu oil, shea butter, mango butter, cocoa butter, wheat germ oil, borage oil, black currant oil, sea-buckhorn oil, macadamia oil, saw palmetto oil, conjugated linoleic oil, arachidonic acid enriched oil, docosahexaenoic acid (DHA) enriched oil, eicosapentaenoic acid (EPA) enriched oil, palm stearic acid, sea-buckhorn berry oil, macadamia oil, saw palmetto oil, or rice bran oil; or margarine or other hydrogenated fats. In some embodiments, for example, the fat is algal oil. The fat can contain the flavoring agent and/or the isolated plant protein (e.g., a conglycinin protein).

In one embodiment, the fat is lecithin, which is any group of yellow-brownish fatty substances occurring in animal and plant tissues which are amphiphilic—they attract both water and fatty substances (and so are both hydrophilic and lipophilic), and are used for smoothing food textures, emulsifying, homogenizing liquid mixtures, and repelling sticking materials.

Lactones

One method of increasing the meat flavor or masking off flavors from plant material in a food product can include adding, to the Admixture 132, Base Substance 135, Meat Analogue 145, etc., one or more lactones at a concentration of 10⁻³ to 10⁻¹¹ of the food product, wherein the lactones are selected from the group consisting of tetrahydro-6-methyl-2H-pyran-2-one, delta-octalactone, 5-ethyldihydro-2(3H)-furanone, butyrolactone, dihydro-5-pentyl-2(3H)-furanone, dihydro-3-methylene-2,5-furandione, 1-pentoyl lactone, tetrahydro-2H-pyran-2-one, 6-heptyltetrahydro-2H-pyran-2-one, gamma-octalactone, 5-hydroxymethyldihydrofuran-2-one, 5-ethyl-2(5H)-furanone, 5-acetyldihydro-2(3H)-furanone, trans-3-methyl-4-octanolide 2(5H)-furanone, 3-(1,1-dimethylethyl)-2,5-urandione, 3,4-dihydroxy-5-methyl-dihydrofuran-2-one, 5-ethyl-4-hydroxy-2-methyl-3(2H)-furanone, delta-tetradecalactone, and dihydro-4-hydroxy-2(3H)-furanone. In some embodiments, the lactones can be 5-ethyl-4-hydroxy-2-methyl-3(2H)-furanone, butyrolactone, gamma-octalactone, and delta-tetradecalactone.

Protein-Fiber Binding Agents

In one embodiment, a binding agent may be provided for assisting in forming the protein plant fiber into a cohesive mixture. The binding agent can be fenugreek, optionally in combination with a plant-based starch.

Texturizing the Meat Analogue

FIG. 1 indicates at 150, the option of texturing the Meat Analogue 145 in order to generate a Final Product 155. There are a number of ways to texturize the product in order to replicate a meat analogue. In one embodiment, the Meat Analogue 145 is texturized by a laminating process. In one embodiment, the Meat Analogue 145 is texturized by extrusion to create the texture of a ground meat.

The Use of Extrusion Technology

With the application of a suitable processing regimen, wet-textured products are identifiable by a fibrous, texture resembling muscle meat. Wet-texturing is a cooking extrusion process in which the protein- and water-rich matrix is prevented from expanding at the die outlet by use of a cooled die.

Extruded products are used extensively in the food industry. The extruder is used primarily to lend the food a specific texture and distinctive mouthfeel. In this context, a wet-textured product is understood to be a product that has been prepared by wet texturing. With the application of a suitable processing regimen, wet-textured products are identifiable by a fibrous, texture resembling muscle meat. Wet-texturing is a cooking extrusion process in which the protein- and water-rich matrix is prevented from expanding at the die outlet by use of a cooled die. Wet-textured products have a water content of about 50-70%, and possess a more or less strongly fibrous, meat-like structure depending on the processing regimen in the extruder and cooling die, to such an extent that they are even used as substitutes for beef and poultry. The use of extrusion technology in food production has a history of more than 70 years, wherein the production of texturized vegetable protein (TVP) using the vegetable proteins such as soybean protein, peanut protein, gluten protein, whey protein and the like as the main raw materials is an important application of the extrusion technology in the food industry. TVP is generally manufactured via passing defatted soy flour containing a certain water content through a high-pressure continuous extruder-cooker to produce an expanded porous structure possessing chewy and elastic textural characteristics imitative of meat. The TVP produced by the extrusion method has excellent functional properties such as water absorption, oil absorption and the like, a cholesterol content of zero and it can be used as additive of meat products or Meat Analogue 145 for consumption.

The TVP can be divided into high-protein TVP (the protein content is more than 70%) and low-protein TVP (the protein content is between 50% and 55%) according to the protein content in raw materials; can be divided into low-moisture TVP (moisture content less than 35%) and high-moisture TVP (moisture content more than 45%) according to the moisture content; and can be divided into ordinary TVP (having a small amount of fibrous structures) and fibrous TVP (having an obvious fibrous structure) according to the fibrous structure of the products.

In one embodiment, texturing, or tempering, of the extrudate in a cooling die. the temperature in the container and/or cooling die is between 50° C. to 12° C., more preferably between 70° C. to 120° C., most preferably between 90° C. to 120° C. Further, the temperature in the container and/or cooling die may decrease from feed to exit, preferably with the temperatures ranges as indicated above. The present texturing step is advantageous for providing the desired crosslinked texture of phenolics, protein (and optionally plant fibers), which closely resembles the texture of muscle meat.

In one embodiment, the pressure in the present container and/or cooling die varies between 10 to 70 bar, more preferably between 15 to 50 bar. In one embodiment, the pressure in the present container or cooling die decreases from feed to exit, preferably with the pressure ranges indicated, such as from 70 or 50 and the feed to 10 or 15 bar at the exit.

In one embodiment, the time period wherein the extrudate is subjected to heat and/or pressure is between 1, 2, 3, to 20 or to 10 minutes. Such as for about 4, 5, 6, 7, 8, 9, 10, 11, 12, 13, 14 or about 15 minutes.

In one embodiment, the present intermeshing screws have an outer diameter to inner diameter ratio from 1.5:1 to 2.5:1. More preferably from 1.6 or 1.7:1 to 2.0 or 2.5:1. The outer diameter is defined as the total diameter of the screw including thread, i.e. the forwarding and reversing paddles, and cylinder or cone. The inner diameter is defined as the diameter of the cylinder or cone. By using intermeshing screws having the indicated ratio, the screw volume is very high. This provides an efficient and industrial scale production of present meat substitute, while remaining its unique quality in terms of structure and tenderness.

In one embodiment, the process comprises extruding the homogenous substance with a velocity of at least 1000 RPM. More preferably with at least 1200 or 1300. Most preferably at least 1400 RPM. ‘RPM’ as used in the present context means revs per minute.

In one embodiment, the Meat Analogue 145 is fed to a Berstorff lab extruder having a capacity of 10 kg/hour. The temperature in the extruders increases from 20° C. to 170° C. The pressure in the extruder was 10 bar, the rotation speed was 400 RPM. The water inflow in the extruder varied from 2 to 4.5 liter/hour, dependent of the water content of the Meat Analogue 145. The extrudate having a temperature of 110° C. was fed into a cooling die by a pressure of 45 bar. The pressure decreased from 45 to 15 bar at the exit of the cooling die. The temperature in the cooling die decreased from 110° C. to 90° C. The residence time of the extrudate in the cooling die, i.e. from feed to exit, was 6 minutes.

In one embodiment on the industrial scale, the Meat Analogue 145 is fed to a co rotating twin screw extruder having intermeshing screws, having an outer/inner diameter of 1.8. The rotational speed was 1200 RPM. During extrusion, the ingredients were heated for providing an extrudate having a temperature of 118° C. The extrudate having a temperature of 118° C. was forced into a cooling die by a pressure of 44 bar. The extrudate remained in the cooling die for 5 minutes, wherein the temperature of the extrudate decreased towards 88° C. The pressure in the cooling die decreased from feed to exit from 44 to 15 bar.

In one embodiment, the Meat Analogue 145 is texturized using an extrusion process using an extruder, a Clextral BC21 co-rotating twin-screw extruder with a 700 mm long barrel that is capable of processing about 8 kg of extruded meat substitute per hour, The screw pitch from the feed section to the die section the screw profile changes from coarse to fine pitch. The extruder is driven by an electrical motor that rotates the two screws at variable speed. In one embodiment, upon the application of heat, shear and pressure the protein material is denatured and aligns into fibers that resemble meat. The denatured fibers then progress into a die, which may be a water-cooled die where the hot product containing up to 60% moisture is cooled and fibration and texturization of the product is finalized. The extruded Final Product 155 is then cut into the required size as determined by the potential end use, for example cubes, slices, strips or chunks, packaged and stored under standard conditions.

Laminating the Meat Analogue

One skilled in the art would appreciate the advantages of texturizing the Meat Analogue by laminating it in a manner analogous to making filo dough, a type of laminated dough. Laminated dough is a culinary preparation consisting of many thin layers of dough separated by butter, produced by repeated folding and rolling.

In commercial production a dough sheeter is used rolls out dough into a (consistent) dough sheet with a desired even dough thickness. Dough is compressed between two or more rotating rollers. When done the right way, a smooth and consistent dough sheet is produced. The dough then passes one or several gauging rollers (mostly on conveyors) that reduce the dough to the required thickness. After this the dough sheet is shaped into a desired dough product

In one embodiment, texturizing the Meat Analogue 145, entails passing the Meat Analogue 145 through two or more rotating rollers to create a sheet, which is then coated with an appropriate fat, the coated sheet folded over on itself to encase the fat within the inner layer and the dough-fat composition fed through the sheeting device. This process is repeated until the desired characteristics of the Final Product 155 are obtained. In one embodiment, texturizing the Meat Analogue 145, entails passing the Meat Analogue 145 through two or more rotating rollers to create an appropriately sheet of an appropriate thickness. This sheet is coated with a fat and another sheet of Meat Analogue 145 which has been passed through two or more rotating rollers is placed on top of the fat, sandwiching the fat between the two layers. This process is repeated until the desired characteristics of the Final Product 155 are obtained.

In one embodiment, the Meat Analogue 145 is supplied to the hopper of a dough feeder (such as Model VX422, available from Rheon Automatic Machinery Co. Ltd., Japan) to form a dough sheet in a belt-like shape that has the width W of 380 mm and the thickness T of 45 mm. The dough sheet is extended in the width direction by means of a cross roller. Then the dough sheet is stretched in both the width and transporting directions by means of a first stretcher (such as Model SM603, available from Rheon) to become a thin sheet that has a width W of 700 mm and a thickness T of 8 mm.

The cross roller is a roller that reciprocates in the width direction of the dough sheet while it rotates so as to stretch the dough sheet in the width direction. Thereby the dough becomes thinner. The first stretcher comprises a lower stretching roller that is disposed downstream in a conveyor for carrying the dough in. It has a large diameter. It also comprises an upper stretching roller that is disposed above the lower stretching roller and has stretching rollers that revolve in a circular pattern while they rotate. The dough that has been stretched in the width direction is stretched in the transporting direction when it passes through the gap between the lower stretching roller and the upper stretching roller. At this time, the speed of the operation of the lower stretching roller, i.e., the speed at the surface of the rotating roller, is set to be 2.9 times the speed of the operation of the conveyor for carrying the dough in.

Then the fat that has been shaped in a required width and a thickness is continuously supplied at the center of the stretched dough sheet by a pump for the fat. The fat in a belt-like shape is put on the upper surface of the dough sheet. Then the side parts of the dough sheet (the edges of the dough sheet where the fat is not put) are folded and overlapped on the fat one by one to form a dough sheet that is wrapped around the fat. The thickness T of it is reduced by means of gauge rollers.

The dough sheet that wraps the fat is stretched by a second stretcher (Model SM601, available from Rheon). This second stretcher stretches the dough sheet by applying vibrations by means of stretching rollers while pulling it. By the second stretcher the speed of the operation of the stretching rollers is set to be 4.4 times the speed of the operation of the conveyor for carrying the dough in.

The stretched dough sheet is folded in a zigzag pattern by means of a first apparatus for laminating the dough sheet (Model LM406, available from Rheon). The dough sheet is stacked in four layers on the lower conveyor that is disposed perpendicular to the transporting direction.

The third stretcher (Model SM032, available from Rheon) has first, second, and third conveyor belts in series in the transporting direction. The respective speeds V1, V2, and V3 of the operations of the first, second, and third conveyor belts become sequentially faster. Upper stretching rollers, each of which has multiple stretching rollers that revolve in an oval pattern while rotating, are provided above the first, second, and third conveyor belts. The respective gaps between the conveyor belts and the upper stretching rollers sequentially become narrower.

The folded dough sheet is pressed against the conveyor belts by means of the stretching rollers of the third stretcher. It is subject to tensile stresses that are generated by the differences in the speeds of the first, second, and third conveyor belts. At the same time, it is vibrated by repeated loads that are generated by the rotations and movements of the stretching rollers (the motion of rotations and revolutions in an oval pattern). The dough sheet that has been stretched in the folded state is stretched to be a sheet of the laminated dough that has a width W of 600 mm and a thickness T of 7 mm and has four alternating dough and fat layers. The speed of the operation of the third conveyor belt is set to be 4.5 times that of the first conveyor belt.

The sheet of the laminated dough with four layers is folded in a zigzag pattern by means of a second apparatus for folding and laminating the dough sheet (Model 0M048, available from Rheon). The sheet of the laminated dough is stacked in four layers on the lower conveyor that is disposed perpendicular to the transporting direction.

The folded sheet of the laminated dough is stretched by a fourth stretcher (Model SM319, available from Rheon). The sheet of the laminated dough that has been stretched in the folded state has 16 alternating dough and fat layers. The speed of the operation of the third conveyor belt is set to be 4.0 times that of the first conveyor belt.

The sheet of the laminated dough is stretched by a fifth stretcher (Model SM319, available from Rheon). The speed of the operation of the third conveyor belt is set to be 1.8 times that of the first conveyor belt. The stretched sheet of the laminated dough that is stretched by the fourth and fifth stretchers is stretched by subjecting it to the repeated loads while being pulled. Thus, the protein network in the dough layers is not broken, and the sheet of the laminated dough can be stretched in a manner that the dough layers and the fat layers correctly alternate.

Aligning the Fibers of the Meat Analogue

In one embodiment, Meat Analogue 145, is texturized by a process analogous to papermaking, wherein the fibers are promoted to align in the same direction with one another. High quality paper typically means good formation, uniform basis weight profiles, uniform sheet structure and high sheet strength properties. These parameters are affected to various degrees by paper fiber distributions, fiber orientations, fiber density and the distributions of fines and fillers.

Paper is made of organic fibers, such as cotton, hemp, and even silk. When paper is machine-made, the fibers are laid down running all in the same direction, usually parallel to the length of the sheet. This creates the grain of the paper. As paper is made, all the fibers within the pulp stew begin to line up in the direction in which the paper machine is moving. The cellulose fibers align, side by side. The plant fibers used for pulp are composed mostly of cellulose and hemi-cellulose, which have a tendency to form molecular linkages between fibers in the presence of water. After the water evaporates the fibers remain bonded.

In one embodiment, texturizing the Meat Analogue 145, entails pouring a thin, wide stream of the viscous material onto a moving “felt” matt. As the leading edge of the protein strings touch the matt, they would be dragged along the matt causing them to straighten into the direction of the matt. The matt would be woven into a “corduroy” rib pattern with 1-2 mm gaps between the ridges (mimicking the width of meat sinews) that would encourage the majority of protein strings into gaps between the ribs. Steel rollers would press the matt to remove moisture and bind the protein into larger strings that would be connected by a thin layer of protein that remained on the ridges of the matt. The ribbed sheet of material could then be optionally coated with fat and/or flavoring before being rolled or folded into its final form.

Food Depositing Technology

There are a number of food depositors known in the art comprising spraying or otherwise extruding the Meat Analogue 145 and/or a sub-component thereof.

In one embodiment the Final Product 155 is basted, glazed, or otherwise deposited with an appropriate as a movable head moves along a track and distributes the fluid over the Final Product 155, which remains stationary during the process.

3D Food Printing Technology

In one embodiment, food grade syringes hold the printing material Meat Analogue 145, which is then deposited through a food grade nozzle layer by layer with a computer-controlled extrusion head onto a standard 3-axis stage. In one embodiment, compressed air or squeezing is used to push the Meat Analogue 145 through the nozzle of the extrusion head as it moves along the 3-axis stage printing the Final Product 155.

One skilled in the art would appreciate that there are a variety of different techniques to employ comprising: hot-melt and room temperature (the extrusion head heats the Meat Analogue 145 slightly above its melting point, which is then extruded from the head and then solidifies soon thereafter); selective laser sintering (powdered Meat Analogue 145 and/or Base Substrate 135 and/or a subcomponent thereof, are heated and bonded together forming a solid structure by bonding the powdered material with a laser as the heat source—each bonded layer it is then covered by a new unbonded layer of powder add selective areas of the unbonded layer are heated by the laser in order to bond it with the structure, continuing upwards); binder jetting (powdered Meat Analogue 145 and/or Base Substrate 135 and/or a subcomponent thereof, use a liquid binder over select areas of the layer, after which a new layer of powder is then spread over the bonded layer covering it, delivering liquid binder over select areas, to bond the new layer to the previous one); inkjet printing (gravity, edible “food ink” is dropped onto the surface of the Meat Analogue 145); multi-printhead and multi-material printing (using either multiple printheads or one printhead and changing the ingredients, multiple ingredients are printed at the same time or in succession). These techniques may be used alone or in combination to generate the Final Product 155 and/or a sub-component, which will be incorporated into the Final Product 155.

In one embodiment, the corduroy analogy rib pattern is generated using selective (ink) jet spraying This technique is one manner to build a steak-like structure, by. selective spraying semisolid fat into a changing series of gaps in the “corduroy” just prior to pouring in material to create a marbling pattern similar to beef, lamb or pork.

Shaping the Final Product

There are a number of well-known processes for shaping the product into a particular form, such as cubes,

Final Product Stabilization Process

In one embodiment, the Final Product 155 is stable at room temperature

In one embodiment, the Final Product 155 is rendered shelf-stable through pasteurization or correction of PH level, dehydration, by adding a preservative, and/or altering the water activity by incorporating salt or sugar.

### EXAMPLES

### Example 1: The General Experimental Details for Examples 2-13

The source of textured pea protein is Puris™ (Turtle Lake, Wis., US) (TPP80-80% 20% starch; Lot No 201215C14. This was ground using a coffee grinder (Black & Decker) each time before use;
The source of powdered pea protein is: Puris™ (Turtle Lake, Wis., US)870 [P870] Lot No 210228T2;
The tannin used is Scott'Tan™ Tannin Complex (purchased from Scott Laboratories, Ltd.; Niagara on the Lake, ON, CAN), which is a proprietary blend of proanthocyanidic (exotic woods) and ellagic (oak) tannins. It is less reactive and more polymerized than some other tannins, thus it integrates well and provides balance;
The white pomace was a blended white pomace obtained from various Okanagan wineries, comprising Sauvignon Blanc and Chardonnay grapes;
The red pomace was a blended pomace obtained from various Okanagan wineries, comprising Merlot, Cab Sauvignon and/or Pinot Noir grapes;
Arrowroot starch and potato starch were obtained from Bulk Barn, Penticton;
The oil is canola oil: No Name®, a generic brand purchased from Great Canadian Wholesale;
The filter paper used to weigh protein, tannin and complexes thereof: Whatman No 1;
The solutions were filtered in a porcelain Buchner Funnel;
Patty components were mixed in a borosilicate beaker and stirred with a stainless-steel stir spoon;
The patties were uniformly formed within a petri dish, on a circle of parchment paper to assist removal and that was then placed on a perforated enameled tray and baked on the center rack of the oven;
The oven used to bake the patties is a convection oven: Whirlpool Gold Stove—Accubake system;
Temperatures are reported in Fahrenheit;
Weights were determined on a small portable digital balance: AMIR Digital Kitchen Scale (accurate to 0.01 g);

### Example 2: Demonstration that Phenolics (e.g., Tannin) Bind to Plant Protein (e.g, Pea Protein)

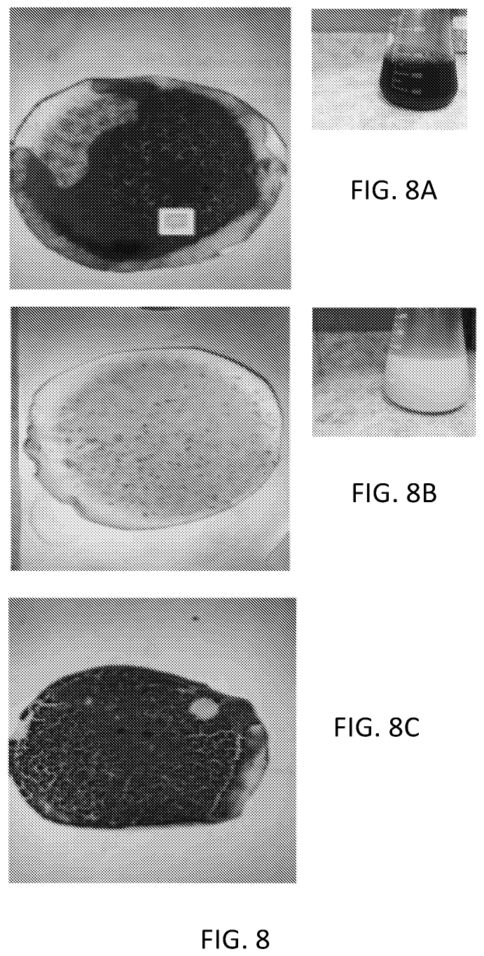

FIG. 8 presents the results from a demonstration that phenolic compounds (e.g., tannin) form complexes with plant proteins (e.g., pea protein).

In this demonstration, 6 grams of powered tannin was added to 100 ml distilled water in an Erlenmeyer flask and stirred with a stirring rod for 2 minutes. To determine the extent that non-complexed tannin is retained by Whatman No 1 filter paper, 50 ml of this solution was withdrawn and filtered through a Buchner funnel, under vacuum. The filter paper including the retained tannin was dried at room temperature for 24 hours and weighed. The filter paper weighed 0.31 g. The weight of filter paper plus retained tannin was 0.42 g, therefore the retained tannin weighed 0.11 g. The visual results are presented in FIG. 8A.

n the same manner, 6 grams of ground textured pea protein was added to 100 ml distilled water in an Erlenmeyer flask and stirred on a stirring plate for 60 minutes. Then to To determine the extent that non-complexed pea protein is retained by Whatman No 1 filter paper, 50 ml of this solution was withdrawn and filtered through a Buchner funnel, under vacuum, the filter paper and retained protein was dried at room temperature for 24 hours and weighed. The weight of filter paper plus retained protein was 0.33 g, so the retained protein weighed 0.02 g. The visual results are presented in FIG. 8B.

To demonstrate the formation of tannin:pea protein complexes, 25 ml of tannin solution and 25 ml of pea protein solution was combined in an Erlenmeyer flask and stirred with a stirring rod for 2 minutes then filtered through a Buchner funnel, under vacuum. The results are presented in FIG. 8C.

These results suggest that the tannin protein complex is less soluble than either the pure tanner solution or the pure protein solution. The decrease in solubility is reflective of the formation of complexes.

### Example 3: Demonstrating the Increase in Complex Formation as the Concentration of Plant Protein (e.g, Pea Protein) is Increased while the Concentration of Phenolics (e.g., Tannin) is Kept Constant

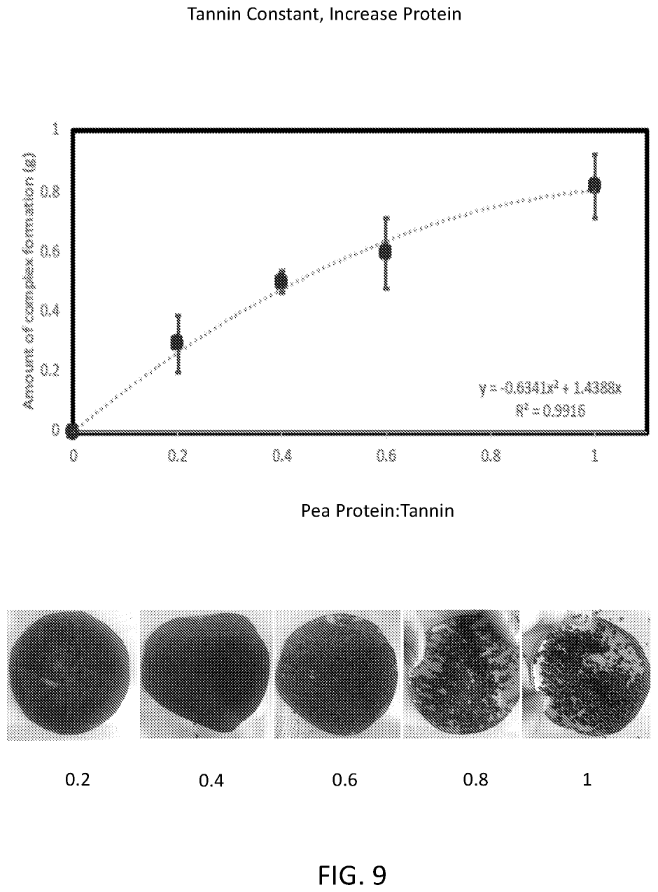

The results for this example are presented in FIG. 9. In order to set the zero point for this demonstration, the filter papers shown in FIGS. 8A and 8B (prepared and weighed as described in Example 2), were subtracted from the weight of each of the filter papers including the retained protein tannin complexes generated in this demonstration [i.e., the combined weights of the residue of the tannin only (0.11 g) and pea protein only (0.02 g) and the weight of one filter paper (0.31 g)]. Filtrate and retentate}.

Stock solutions were prepared by adding 6 grams of powered tannin to 100 ml distilled water in an Erlenmeyer flask and stirred with a stirring rod for 2 minutes. Likewise, 6 grams of powdered ground textured pea protein (80%) were added to 100 ml distilled water in a separate Erlenmeyer flask and stirred on a stirring plate for 60 minutes.

The protein:tannin ratio was increased stepwise by first withdrawing 50 ml from the tannin stock solution, 10 ml of the protein stock solution, and combining them in an Erlenmeyer flask and stirred with a stirring rod for 2 minutes. To establish the weight for any complexes, this solution was filtered through a Buchner funnel, under vacuum. The filter paper was dried at room temperature for 24 hours and weighed. As indicated above, the weight of the pure tannin and pea protein and the weight of the filter papers were subtracted from this number. The results are presented in FIG. 9 as 0.2 pea protein:tannin ratio.

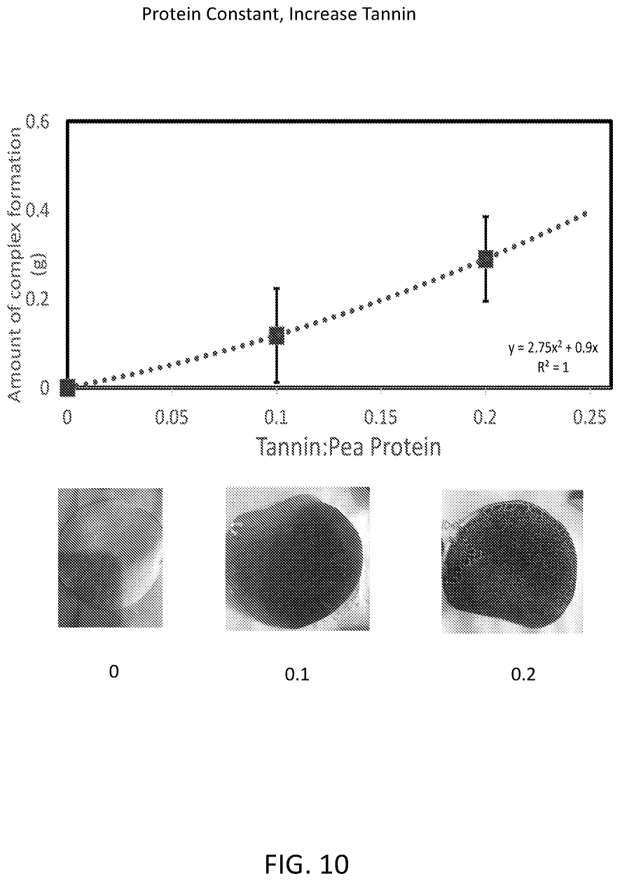

This process was repeated using: 50 ml tannin stock and 20 ml of protein stock (FIG. 10 as 0.4 protein:tannin); 50 ml tannin stock and 30 ml protein stock (FIG. 9 as 0.6 protein:tannin); 50 ml tannin stock and 40 ml protein stock (FIG. 9 as 0.8 protein:tannin); and 50 ml tannin stock and 50 ml protein stock (FIG. 9 as 1.0 protein:tannin).

### Example 4: Demonstrating the Increase in Complex Formation as the Concentration of Phenolics (e.g., Tannin) is Increased while the Concentration of Plant Protein (e.g, Pea Protein) is Kept Constant

The results for this example are presented in FIG. 10. In order to set the zero point for this demonstration, the filter papers shown in FIGS. 8A and 8B (prepared and weighed as described in Example 2), were subtracted off of the weight of each of the filter papers including retained protein tannin complexes generated in this demonstration [i.e., the combined weights of the residue of the tannin only (0.11 g) and pea protein only (0.02 g) and the weight of one filter paper (0.31 g)].

Stock solutions were prepared by adding 6 grams of powered tannin to 100 ml distilled water in an Erlenmeyer flask and stirred with a stirring rod for 2 minutes. Likewise, 6 grams of powdered ground textured pea protein (80%) was added to 100 ml distilled water in a separate Erlenmeyer flask and stirred on a stirring plate for 60 minutes.

The protein:tannin ratio was increased stepwise by first withdrawing 50 ml from the tannin stock solution, 10 ml of the protein stock solution, and combining them in an Erlenmeyer flask and stirred with a stirring rod for 2 minutes. To establish the weight for any complexes, this solution was filtered through a Buchner funnel, under vacuum. The filter paper was dried at room temperature for 24 hours and weighed. As indicated above, the weight of the pure tannin and pea protein and the weight of the filter papers were subtracted from this number. The results are presented in FIG. 10 as 0.1 tannin:protein ratio (x g)

This process was repeated using: 50 ml tannin stock and 20 ml of protein stock (FIG. 10 as 0.2 tannin:protein);

### Example 5: Demonstrating Optimal Oil Concentration for Emulsifying a Fruit-Based FVNG-Pomace Prior to Combining with Protein Powder

The objective of this demonstration was to make a patty comprising 50 grams of either white pomace or red pomace, wherein the pomace was emulsified with different amounts of oil, prior to combining with the pea protein in a 50:50 ratio of pomace:pea protein. The following steps were performed with white pomace and then repeated with red pomace, both including the stepwise increase of canola oil, to elucidate the optimal oil concentration for emulsifying the pomace.

The first step was to preheat the oven to 300° F. While the oven was heating, 200 grams of either white or red pomace and 40 grams of oil were combined and emulsified by blending with Ninja blender (Professional) at the soup setting for 1:30 min. Then 60 grams of the pomace/oil emulsion was combined with 30 grams textured pea protein and mixed with a stirring rod for 5 minutes. A patty was formed in a petri dish, was removed, placed in the oven and baked at 300° F. for 30 minutes. This generated a patty with a 11.1%:55.6%:33.3% ratio (by weight) of oil: pomace: protein.

To generate a patty with a 20%: 50%: 30% ratio (by weight) of oil:pomace:protein, 30 grams of oil was added to the remaining 180 g of the pomace/oil emulsion, which was emulsified by blending with Ninja blender at the soup setting for 1:30 min. Then 70 grams of this pomace/oil emulsion was combined with 30 grams textured pea protein, and mixed with a spoon for 5 minutes. A patty was formed in a petri dish, was removed, placed in the oven and baked at 300° F. for 30 minutes.

To generate a patty with a 27.2%: 45.5%: 27.3% ratio (by weight) of oil:pomace:protein, 20 grams of oil was added to 120 grams of the remaining pomace/oil emulsion, which was then emulsified by blending with Ninja blender at the soup setting for 1:30 min. Then, 80 grams of this pomace/oil emulsion was combined with 30 grams textured pea protein, and mixed with a spoon for 5 minutes. A patty was formed in a petri dish, was removed, placed in the oven and baked at 300° F. for 30 minutes.

Our observations were that the ratio of 27.2%: 45.5%: 27.3% of oil:pomace:protein (by weight) is too oily in that it generates an oily flavor using sensory attributes including smell and taste. The ratio of 20%: 50%: 30% ratio (by weight) and 11.1%:55.6%:33.3% ratio of oil:pomace:protein (by weight) both did not generate the oily flavor and provided a better ratio of these ingredients. The oil is there to create stable emulsion and the observation that 27.2%

### Example 6: Demonstration of Different Types of Binding Agents and their Role in Meat-Like Formulations Comprising Complexes of Phenolics and Plant Protein

Different binding agents: potato starch, arrowroot flour, Guar gum and locust gum were separately used in this demonstration to show how one or more binding agent(s) can be incorporated in the composition to increase the elasticity of the patty (reduce the “crumbliness”) of a plant protein, phenolic compounds and oil formulation.

This demonstration mixed 50 grams of either white or red pomace, with 10 grams canola oil. The mixture was stirred in beaker using stainless steel spoon for 5 minutes. Once the oil emulsified with the pomace, 10 grams of one of the binding agents and 30 grams texturized pea protein was added with stirring using a spoon for 5 minutes. A patty was formed in a petri dish using the entire mixture and was baked in the petri dish at 300° F. for 30 minutes.

This procedure was repeated for each of the binding agents.

After the patties cooled for 30 minutes, they were assessed by touch, smell, mouth feel and taste. Each patty was broken and felt for firmness and tested for elasticity by bending it (if it fractured, it was deemed crumbly, if not, it was deemed elastic). All the patties were less crumby then the control, but the patties formed with the Guar Gum and locust gum had an aftertaste and a bitter flavor in the mouth. Both the potato starch and arrowroot reduced crumbliness considerably. The patty comprising arrowroot was slightly more hydrated then the potato starch patty.

### Example 7: Demonstration of Different Concentration of Binding Agents and their Role in Meat-Like Formulations

Two exemplary binding agents: potato starch and arrowroot flour were used separately in this demonstration to show ideal concentrations thereof to reduce the “crumbliness” of a plant protein and fruit-based source of phenolic compounds and oil formulation.

This demonstration mixed 50 grams of red pomace, and 10 grams canola oil, stirred in beaker using a spoon for 5 minutes. Once the oil had been emulsified, 30 grams of texturized pea protein and 5 grams of one potato starch was added by stirring with a spoon for 5 minutes. A patty was formed in a petri dish using the entire mixture was baked in the petri dish at 300° F. for 30 minutes.

This demonstration mixed 50 grams of red pomace, and 10 grams canola oil, stirred in beaker using a spoon for 5 minutes. Once the oil had been emulsified, 30 grams of texturized pea protein and 10 grams of potato starch was added by stirring with a spoon for 5 minutes. A patty was formed in a petri dish using the entire mixture and was baked in the petri dish at 300° F. for 30 minutes.

This demonstration mixed 50 grams of red pomace, and 10 grams canola oil, stirred in beaker using a spoon for 5 minutes. Once the oil had been emulsified, 30 grams of texturized pea protein and 15 grams potato starch was added by stirring with a spoon for 5 minutes and a patty was formed in a petri dish using the entire mixture. This patty was baked in the petri dish at 300° F. for 30 minutes.

The procedure was repeated using arrowroot powder in place of the potato starch. One additional trial was conducted using 10 grams arrowroot powder and 10 grams water.

After the patties cooled for 30 minutes, they were assessed by touch, smell, mouth feel and taste. Each patty was broken and felt for firmness and tested for elasticity by bending it (if it fractured, it was deemed crumbly, if not, it was deemed elastic). Arrowroot formed a more hydrated patty and provided more of the desired consistency. As the concentration of arrowroot increased, the pliability of the patties increased and became harder to break. The patty comprising potato starch was a little dry but was firm. All concentrations of potato starch provided the same results and it did bind the patties together.

### Example 8: Demonstration of Ratios of Pomace to Hydrated Pea Protein and their Effect Un Meat Analogue Formulations

In this demonstration, a series of red pomace and texturized pea protein formulations were prepared in separate beakers:
50 grams pomace and 30 grams pea protein;
40 grams pomace and 40 grams pea protein;
30 grams pomace and 50 grams pea protein; and
30 grams pomace and 50 grams hydrated pea protein (50 ml of distilled water was added with stirring and the mixture sat for 30 minutes);

Then 10 grams of potato starch were added to each of the pomace/protein formulations, by stirring with a spoon for 5 minutes. A patty was formed in a petri dish using the entire mixture and was baked in the petri dish at 300 F for 30 minutes.

After the patties cooled for 30 minutes, they were assessed by touch, smell, mouth feel and taste. Each patty was broken and felt for firmness and tested for elasticity by bending it (if it fractured, it was deemed crumbly, if not, it was deemed elastic). As the concentration of pea protein increased, the crumbliness of the patty also increased. Hydrating the pea protein gave the patty more texture and a hydrated feeling in the mouth, in contrast to the non-hydrated pea protein patties which had more of a dry mouth feel. No difference was observed for the ratio of pomace to pea protein.

### Example 9: Demonstration of a Fermented FVNG-pomace in Combination with Hydrated Plant Protein Source and Increasing Plant Protein Concentrations

For this demonstration, decreasing amounts of fermented red pomace were added to hydrated pea protein, oil and starch mixtures, to form patties that were baked. (The pea protein/water mixtures comprised much less water than the mixture in Example 2, so stirring them by hand was more effective than the magnetic bar and the stir plate).

For the first patty, 40 grams of textured pea protein was hydrated with 60 grams distilled water by stirring for 2 minutes, then 20 grams of canola oil and 20 grams of potato starch were added and the mixture stirred for 2 minutes. Once all ingredients were well mixed, 50 grams of this mixture was withdrawn and placed in a separate beaker to which 40 grams red fermented pomace (Marlee) was added and mixed with a spoon for 5 minutes. A patty was formed in a petri dish using the entire mixture comprising fermented pomace and was baked in the petri dish at 300° F. for 30 minutes.

For the second patty, 40 grams of textured pea protein was hydrated with 60 grams distilled water by stirring for 2 minutes, and then 20 grams of canola oil and 20 grams of potato starch were added and the mixture stirred for 2 minutes. Then 50 grams of this mixture was withdrawn and placed in a separate beaker to which 30 grams red fermented pomace was added and mixed with a spoon for 5 minutes. A patty was formed in a petri dish using the entire mixture and was baked in the petri dish at 300° F. for 30 minutes.

For the third patty, 40 grams of textured pea protein was hydrated with 60 grams distilled water and stirred for 2 minutes, then 20 grams of canola oil and 20 grams of potato starch were added and the mixture stirred for 2 minutes. Then, 50 grams of this mixture was withdrawn and placed in a separate beaker to which 15 grams red fermented pomace was added and mixed with a spoon for 5 minutes. A patty was formed in a petri dish using the entire mixture and was baked in the petri dish at 300° F. for 30 minutes

After the patties cooled for 30 minutes, they were assessed by touch, smell, mouth feel and taste. Each patty was broken and felt for firmness and tested for crumbliness. As the relative concentration of pea protein increased (i.e., smaller amounts of pomace were added), the crumbliness of the patty also increased. The optimal ratio in this demonstration was obtained with first patty comprising 50 g of protein/oil/starch and 40 g of fermented pomace, as this ratio produced the firmest and most pliable patty. As the percentage of the fermented pomace in the patties decreased the firmness of the patties also decreased.

There were some differences in the taste and texture of the patties made with fermented red pomace versus red pomace (Examples 2-7). Fermented red pomace is more hydrated than red pomace. When forming the patty, more pomace can be added to the patties and they will not lose their firmness until about 50% of the total weight of the patty is achieved.

Whereas, for fermented red pomace, the threshold is about 40% of the total weight of the patty. If more fermented red pomace is added then the patty does not have much structure and falls apart very easily. Since fermented red pomace is has undergone the transformation by fermentation and is industrially finely ground, it does provide the patty with more color and a uniform look. The fermented pomace exhibits the consistency and look of a “smoothie,” whereas the unfermented pomace looks more like a dry chili.

### Example 10: Demonstration that Processing Pomace in a Colloid Mill Renders Fruit Seeds Able to be Incorporated in a Food Product

In this demonstration, a Woltop Peanut Butter Maker was purchased from Amazon and used as a colloid mill to pre-process the pomace by grinding the seeds contained therein. This process not only made the patty more palatable (i.e., breaking down the seeds, it reduced the “crunchiness” of the patty), but also added to the amount of phenolic compounds available to form complexes with the pea protein, as grape seeds are known to be rich in phenolic compounds.

For the first patty, 40 grams of ground textured pea protein was hydrated with 120 grams distilled water by stirring for 2 minutes. 20 grams of canola oil and 20 grams of potato starch were added. Then, 70 grams of this mixture was withdrawn and placed in a separate beaker to which 40 grams pomace was added and mixed with a spoon for 5 minutes. A patty was formed in a petri dish using the entire mixture and was baked in the petri dish at 300° F. for 30 minutes.

For the second patty, 40 grams of ground textured pea protein was hydrated with 120 grams distilled water by stirring for 2 minutes and then 20 grams of potato starch were added. Then, 50 grams of this mixture was withdrawn and placed in a separate beaker. 30 grams pomace was added to 20 g of canola oil extruded through the peanut butter machine 4 times. and mixed with the with a spoon for 5 minutes. A patty was formed in a petri dish using the entire mixture and was baked in the petri dish at 300° F. for 30 minutes.

By grinding the seeds in the pomace, the colloid mill reduced the crunch of the patties and by emulsifying the oil into the pomace, this process gave the patties a more uniform feel. The 1:3 ratio between pea protein: water was too much water content for the patties and resulted in a mushy patty.

### Example 11: Demonstration of Appropriate Hydration of Pea Protein Affecting Moisture Levels in a Patty

A pea protein, water and binder formulation was prepared by combining 50 grams of powdered pea protein, 100 grams distilled water and 30 grams of a binder agent (5 grams arrowroot flour and 25 grams potato starch) in a beaker and mixing with a spoon for 5 minutes. It was mixed by hand because it was highly viscous.

A white pomace/oil formulation was prepared by emulsifying 80 grams of white pomace with 20 grams canola oil using the peanut butter maker. This mixture was extruded through the peanut butter maker 4 times. A separate red pomace/oil formulation was prepared in the same way.

Patties were prepared by combining the following amounts of each formulation in separate beakers:
1. 50 g white pomace/oil+50 g protein/water/binding agent
2. 40 g white pomace/oil+30 g protein/water/binding agent and 20 g water
3. 50 g red pomace/oil+50 g protein/water/binding agent
4. 40 g red pomace/oil+30 g protein/water/binding agent+20 g water

Each mixture was combined in a beaker and mixed with a spoon for 5 minutes. A patty was formed in a petri dish using the entire mixture from each beaker and was baked in the petri dish at 300° F. for 30 minutes.

After the patties cooled for 30 minutes, they were assessed by touch, smell, mouth feel and taste. Each patty was broken and felt for firmness and tested for elasticity by bending it (if it fractured, it was deemed crumbly, if not, it was deemed elastic). No noticeable differences were seen with the red versus white pomace. The flavor of the patties was neutral and provided a good baseline for a targeted flavor profile. The water content for each patty was very similar. The water content in the patties did not change the taste and the texture of the resulting cooked product. They all had a soft interior and a hard exterior.

### Example 12: Demonstration that the Form of Pea Protein Affects the Complexing with a FVNG-Pomace

The dry ingredients comprising 15 grams of powdered pea protein and 8 grams of potato starch were combined in a beaker. Likewise, 15 grams of ground textured pea protein and 8 grams of potato starch were combined in a separate beaker. After the contents of each beaker were well mixed with a spoon, 40 grams of red pomace was mixed into each beaker with stirring. Once these were well mixed, 10 grams of oil and 27 grams distilled water were added to each beaker, the contents stirred with a spoon for 5 minutes to thoroughly combine all the components. A patty was formed in a petri dish using the entire mixture from each beaker and was baked in the petri dish at 300° F. for 30 minutes.

After the patties cooled for 30 minutes, they were assessed by touch, smell, mouth feel and taste. Each patty was broken and felt for firmness and tested for crumbliness. The patties that were formed with powdered pea protein had more elasticity and were of a more uniform texture than the patties made using texturized pea protein. Since the texturized pea protein could not be ground as finely as the powered pea protein, small fragments of pea protein were more visible in that patty compared to the powdered pea protein patty.

### Example 13: Demonstration of a Recipe for a Vegetable Burger Comprising Fermented Red Pomace and Multiple Plant Proteins

This table presents the amount of the various components incorporated into this demonstration of a meat analogue burger. The red fermented pomace was prepared from Merlot, Cabernet Franc, Pinot Noir, Cabernet Sauvignon, Syrah, and Malbec grapes. The pomace was ground, water added, an acetic acid bacteria, added, and the mixture was fermented for six months.

| | | |
|---|---|---|
| Ingredients | Imperial | Metric (Grams) |

| | | | |
|---|---|---|---|
| Chickpeas | 3.5 | Cups | 448 |
| Brown Rice | 2 | Cups | 256 |
| Gluten Free Breadcrumbs | 2 | Cups | 256 |
| Coconut Butter | 6 | oz | 170 |
| BBQ Sauce | 4 | Tbs | 68 |
| Smoked Paprika | ¼ | Tbsp | 4.25 |
| Chilli Powder | 1 | Tbsp | 17 |
| Cumin Powder | 1 | Tbsp | 17 |
| Ground Pepper | ½ | Cup | 8.5 |
| Diced Onion | ½ | Cup | 64 |
| Diced Carrots | 1 | Cup | 64 |
| Soaked Shiitake Mushrooms | 4 | Tbsp | 200 |
| Canola Oil | 4 | Tbsp | 85 |
| Tofu (pressed) | 5 | Tbsp | 350 |
| Pea Protein | 1½ | Cup | 51 |
| Fermented Red Puree | 3 | Tbsp | 68 |
| Salt | ¼ | Tbsp | 2.1 |

The tofu was placed on an absorbent layer of paper towels and let sit for 20 minutes. The Shiitake mushrooms in a bowl of boiling water, covered with plastic wrap to keep warm for 30 minutes, after which they were removed from the water, de-stemmed and quartered.

A pot containing 4 cups of water was brought to boil and the rice was added, the temperature reduced as necessary to prevent overflow, with a continuous steady boil, uncovered for 30 minutes. The water was drained off and the cooked rice was placed on a cookie sheet to cool. Once the rice was cool, it was added to a mixing bowl.

The carrots and onions were chopped and cooked for 2 minutes in a medium hot pan and then removed to let cool. Once they were cool, they were added to the mixing bowl.

The breadcrumbs were combined with the rest of the dry ingredients in a separate mixing bowl.

The tofu, chickpeas, diced carrots, diced onions and Shiitake mushrooms were blended in a food processor for 10 seconds and added into the dry ingredients.

The BBQ sauce, Canola oil, Smoke extract and coconut butter were added and the mixture mixed with a spoon, until all ingredients were well mixed.

The mixture was weighed into seventeen 120-gram balls, then patted and formed into round veggie patties. They were placed on a cookie sheet and baked in the oven at 350 degrees F. for 20 minutes. These were then fried in a pan for 5 minutes to generate a crispy exterior

### Example 14: Demonstration of a Standard Formula for a Reduced Sodium Meat Analogue Burger, with and without Fermented Red Pomace

This table presents the amount of the various components incorporated into this example of a meat analogue burger. This demonstration used 1.44 grams as the standard amount of salt contained within a pea protein meat analogue, so for these reduced sodium versions of a meat analogue, 0.3 grams of salt were used. The red fermented pomace was prepared from Merlot, Cabernet Franc, Pinot Noir, Cabernet Sauvignon, Syrah, and Malbec grapes. The pomace was ground, water added, acetic acid bacteria was added, and the mixture was fermented for six months.

| | 80% Sodium | With Fermented |
|---|---|---|
| Ingredients | Control | Red Pomace |
| Water 1 | 50 | 50 |
| Roquette TPP | 25 | 25 |
| Water 2 | 34 | 34 |
| Pea protein | 5 | 5 |
| Salt | 0.3 | 0.3 |
| Coconut oil chunks | 10 | 10 |
| Chili powder | 1 | 1 |
| Cumin powder | 0.5 | 0.5 |
| Onion powder | 1 | 1 |
| Garlic powder | 1 | 1 |
| Ground pepper | 0.3 | 0.3 |
| Liquid Smoke | 0.3 | 0.3 |
| Methyl cellulose | 5 | 5 |
| BBQ sauce | 1 | 1 |
| Fermented red pomace | | 3 |

Textured pea protein was added to a stainless-steel mixing bowl. The fermented pomace (if to be added), BBQ sauce, Liquid Smoke and Water 1 were added and mixed within a separate container, and this liquid mixture was added to the textured pea protein. This mixture was stirred with a mixing spoon for approximately 20 seconds until the water begins to absorb. This mixture was set aside for 8 minutes to allow for full absorption.

The powdered ingredients (powdered pea protein, chili powder, cumin powder, onion powder, garlic powder, ground pepper, potato starch, and salt) were added to a second stainless steel bowl and were combined together by using a whisk. The Water 2 was added into the bowl and the ingredients were incorporated together by using a spatula.

Once the textured pea protein sat for 8 minutes absorbing water, the hydrated textured pea protein was transferred from the stainless-steel bowl into the second stainless steel bowl comprising the rest of the ingredients and mixed together. These ingredients were left to marinate for 30 minutes by covering the top of the bowl opening with saran wrap and placing it in the refrigerator for 30 minutes or until the mixture reached 40 degrees.

Once all ingredients were marinated, the mixture was removed from the refrigerator. The saran wrap was removed and Expeller Press Coconut chunks were added into the mixture and lightly incorporated. The mixture was formed into two 120-gram circular patties, about ½ inch thick. Each patty was placed onto parchment paper, then onto a cookie sheet, which was placed into a freezer to set overnight.

To cook the patties the next day, a non-stick pan was placed on a stove top and the burner was set to medium hot heat. A patty was placed in the pan and cooked for 6 minutes. The burger was flipped and cooked for another 6 minutes. The burger was removed from the pan and let cool for one minute.

The patties were tested for sensory evaluation by:
1) Placing s bite size piece of the control Meat Analogue in the mouth;
2) Chewing and placing on tongue and applying pressure to the roof of the mouth, repeat for 20 seconds;
3) Allow the sample to cover all taste buds of the tongue;
4) Complete the 5 sensory evaluations on the chart provided below;
5) Repeat for the Meat Analogue Burger comprising fermented red pomace.

| | Appearance | Aroma | Texture | Flavor | Aftertaste | Total |
|---|---|---|---|---|---|---|
| Control 80% | 1 2 3 4 5 | 1 2 3 4 5 | 1 2 3 4 5 | 1 2 3 4 5 | 1 2 3 4 5 | _/25 |
| Burger | | | | | | |
| Notes | | | | | | |
| Fermented | 1 2 3 4 5 | 1 2 3 4 5 | 1 2 3 4 5 | 1 2 3 4 5 | 1 2 3 4 5 | _/25 |
| Pomace | | | | | | |
| Burger | | | | | | |
| Notes | | | | | | |

Score value Assigned:
5 = like very much;
4 = like moderately;
3 = neither like nor dislike;
2 = dislike moderately;
1 = dislike very much

The patties were tested for sensory evaluation by and the findings were:

Score value Assigned: 5 = like very much; 4 = like moderately; 3 = neither like nor dislike;
2 = dislike moderately; I = dislike very much

| | Appearance | Aroma | Texture | Flavor | Aftertaste | Total |
|---|---|---|---|---|---|---|
| Control | 1 2 3 4 5 | 1 2 3 4 5 | 1 2 3 4 5 | 1 2 3 4 5 | 1 2 3 4 5 | 10/25 |
| 80% Burger | | | | | | |
| Notes | Light brown, | Bland pea | Chewy, | Light spice, | Strong pea | |
| | chickpea | protein light | dense texture | strong pea | flavor | |
| | style burger | spice | | flavor | | |
| Fermented | 1 2 3 4 5 | 1 2 3 4 5 | 1 2 3 4 5 | 1 2 3 4 5 | 1 2 3 4 5 | 23/25 |
| Pomace | | | | | | |
| Burger | | | | | | |
| Notes | Deeper | Enhanced | Less dense | Pea flavor | Enhanced | |
| | brown color, | spice notes | bite; good | masked, | spice, well | |
| | resemblance | | chew | enhance spice | rounded | |
| | to a beef | | | and salt | | |
| | patty | | | flavor | | |

Adding the red fermented pomace to a meat analogue formulation with an example 80% sodium reduction enhanced umami flavors while improving mouth feel and provided a “rounding off” of the taste. The appearance was deeper brown. The aroma exhibited enhanced smoke and spice notes. The texture was chewy and exhibited a more dense structure. (suggests cross-linking function of the phenolics of red pomace—ground seeds (phenolics)—25% sugar, malic and tartaric, fat,) The salt flavor was enhanced even with 80% reduction in salt content. It masked the blandness of the pea protein flavors while heightening smoky and umami notes. The aftertaste provided an enriched spice flavor but well rounded, with no wine taste. (lactic acid, tartaric acid)

### Example 15: Demonstration of a Standard Formula for a Reduced Sodium Chicken Analogue Burger, with and without Fermented White Pomace

This table presents the amount of the various components incorporated into this demonstration of a meat analogue burger. This demonstration used 1.44 grams as the standard amount of salt contained within a pea protein meat analogue, so for these reduced sodium versions, 0.3 grams of salt were used. The White Fermented Pomace was prepared from Gewurztraminer, Pinot Gris, Kerner, Viognier Malbec grapes. The pomace was ground, water added, acetic acid was added, and the mixture was fermented for six months.

| | 80% Sodium | With Fermented |
|---|---|---|
| Ingredients | Control | White Pomace |
| Water 1 | 60 | 60 |
| Textured pea protein | 25 | 25 |
| Water 2 | 34 | 34 |
| Powdered pea protein | 5 | 5 |
| Salt | 0.3 | 0.3 |
| Coconut oil | 10 | 10 |
| Vegan chicken stock | 3 | 3 |
| Cumin powder | 0.5 | 0.5 |
| Thyme | 0.3 | 0.3 |
| Oregano | 0.1 | 0.1 |
| Ground pepper | 0.2 | 0.2 |
| Methyl cellulose | 3 | 3 |
| BBQ sauce | 1 | 1 |
| Fermented Pomace | | 3 |

Textured pea protein was added to a stainless-steel mixing bowl. The fermented pomace (if to be added), BBQ sauce, Liquid Smoke and Water 1 were added and mixed within a separate container, and this liquid mixture was added to the textured pea protein. This mixture was stirred with a mixing spoon for approximately 20 seconds until the water begins to absorb. This mixture was set aside for 8 minutes to allow for full absorption.

The powdered ingredients (powdered pea protein, cumin powder, thyme, ground pepper, methyl cellulose and salt) were added to a second stainless steel bowl and were combined together by using a whisk. The Water 2 was added into the bowl and the ingredients were incorporated together by using a spatula.

Once the textured pea protein sat for 8 minutes absorbing water, the hydrated textured pea protein was transferred from the stainless-steel bowl into the second stainless steel bowl comprising the rest of the ingredients and mixed together. These ingredients were left to marinate for 30 minutes by covering the top of the bowl opening with saran wrap and placing it in the refrigerator for 30 minutes or until the mixture reached 40 degrees.

Once all ingredients were marinated, the mixture was removed from the refrigerator and was formed into two 120-gram circular patties, about ½ inch thick. Each patty was placed onto parchment paper, then onto a cookie sheet, which was placed into a freezer to set overnight.

To cook the patties the next day, a non-stick pan was placed on a stove top and the burner was set to medium hot heat. A patty was placed in the pan and cooked for 5 minutes until golden brown. The burger was flipped and cooked for another 5 minutes. The burger was removed from the pan and let cool for one minute.

The patties were tested for sensory evaluation as described in Example 14 and the findings were that the appearance of the chicken burger analogue including fermented white pomace was a light beige, with minimal color change. The aroma exhibited enhanced salt and spice notes. The texture was chewy and had a more dense structure. The flavor had an enhanced salt flavor, and the blandness from the pea protein flavors was masked while heightening the sodium and spice notes. The aftertaste included an enriched spice and chicken flavor but was well rounded with no wine taste.

1. A composition comprising FVNG-pomace and one or more plant proteins, wherein a portion of the FVNG-pomace is FVNG-pomace phenolics, wherein the ratio of FVNG-pomace to the one or more plant proteins consists of about 5% to 200% (dry w/w).

2. A composition according to claim 1, wherein the ratio of FVNG-pomace to the one or more plant proteins consists of about 5% to 50% (dry w/w).

3. A composition according to claim 1, wherein the ratio of FVNG-pomace to the one or more plant proteins consists of about 50% to 100% (dry w/w).

4. A composition according to claim 1, wherein the ratio of FVNG-pomace to the one or more plant proteins consists of about 100% to 150% (dry w/w).

5. A composition according to claim 1, wherein the ratio of FVNG-pomace to the one or more plant proteins consists of about 150% to 200% (dry w/w).

6. A composition according to claim 1, wherein the composition additionally comprises one or more of exogenous:
a. starches;
b. fats or oils;
c. carbohydrate;
d. gums;
e. hydrocolloids;
f acidulants;
g. stabilizers;
h. emulsifiers;
i. flavor precursors;
j. protein-fiber binding agents;
k. lactones;
l. colorings;
m. Plant-based fibers;
n. Fungal mycelium
o. antioxidants; and
p. phenolics.

7. A composition according to claim 1 comprising a complex of one or more plant proteins and FVNG-pomace phenolics, wherein the percentage of plant proteins that are complexed with phenolics is about 5% to 100%.

8.-12. (canceled)

13. A composition according to claim 7, wherein the composition additionally comprises one or more of exogenous:
a. starches;
b. fats or oils;
c. carbohydrate;
d. gums;
e. hydrocolloids;
f. acidulants;
g. stabilizers;
h. emulsifiers;
i. flavor precursors;
j. protein-fiber binding agents;
k. lactones;
l. colorings;
m. Plant-based fibers;
n. Fungal mycelium
o. antioxidants; and
p. phenolics.

14.-21. (canceled)

22. A meat analogue comprising FVNG-pomace and one or more plant proteins, wherein a portion of the FVNG-pomace is FVNG-pomace phenolics, wherein the ratio of FVNG-pomace to the one or more plant proteins consists of about 5% to 200% (dry w/w).

23.-26. (canceled)

27. A meat analogue according to claim 22 comprising a complex of one or more plant proteins and FVNG-pomace phenolics, wherein the percentage of plant proteins that are complexed with phenolics is about 5% to 100%.

28.-32. (canceled)

33. A meat analogue according to claim 22 wherein the meat analogue was processed by a texturizing means.

34. A meat analogue according to claim 27, wherein the meat analogue was processed by a texturizing means.

35.-37. (canceled)

38. A composition according to claim 1, wherein the FVNG-pomace has been fermented prior to combining with the one or more plant proteins.

39. A composition according to claim 1, wherein the FVNG-pomace is fermented FVNG-pomace.

40. A composition according to claim 6, wherein the FVNG-pomace has been fermented prior to combining with the one or more plant proteins.

41. A composition according to claim 6, wherein the FVNG-pomace is fermented FVNG-pomace.

42. A method of making a composition comprising FVNG-pomace and one or more plant proteins, wherein the ratio of FVNG-pomace to the one or more plant proteins consists of about 5% to 200% (dry w/w), comprising the steps of:
a. Optionally preparing one or more sources of plant protein;
b. Preparing FVNG-pomace;
c. Optionally fermenting the FVNG-pomace;
d. Combining one or more sources of protein with FVNG-pomace and/or fermented FVNG-pomace to generate protein-polyphenol complexes in either an Admixture or a Base Substance;
e. Optionally, conducting one or more Modification Steps to the Admixture or Base Substance; and
f. Optionally, formulating into a Meat Analogue.

43. The method of claim 42 for making a composition comprising a complex of one or more plant proteins and FVNG-pomace phenolics, wherein the percentage of plant proteins that are complexed with phenolics is about 5% to 100%.

44. A method of using a composition of claim 1 to modify the sensory qualities of a meat analogue, wherein the ratio of FVNG-pomace to the one or more plant proteins consists of about 5% to 200% (dry w/w) to add to a meat analogue formulation to modify the sensory qualities thereof.

45. The method of claim 44 wherein the percentage of plant proteins that are complexed with phenolics is about 5% to 100%.
